(19) United States
(12) Patent Application Publication
(10) Pub. No.: US 2012/0152202 A1
(43) Pub. Date: Jun. 21, 2012

(54) FUEL INJECTION VALVE

(75) Inventor: Toshikuni Kurokawa, Nagoya-shi (JP)

(73) Assignee: TOYOTA JIDOSHA KABUSHIKI KAISHA, Toyota-shi, Aichi (JP)

(21) Appl. No.: 13/379,703

(22) PCT Filed: Jul. 21, 2009
(86) PCT No.: PCT/JP2009/063053

§ 371 Date: Dec. 21, 2011

(51) Int. Cl. F02M 61/18; F02B 31/00

(52) U.S. Cl. 123/298; 123/445; 239/533.12

(57) ABSTRACT

A fuel injection valve having a nozzle body having nozzle holes in a tip portion thereof, where fuel led into the nozzle body is injected from the nozzle holes, the fuel injection valve including a first swirl member for generating a first swirl flow in a part of the fuel in the nozzle body; and a second swirl member for generating a second swirl flow in a part of remaining fuel in the nozzle body, the first and second swirl members being mounted so that, as viewed along a center line of the nozzle hole, the first swirl flow is located on one side of an inlet opening of the nozzle hole, while the second swirl flow is located on the other side of the inlet opening, and the first and second swirl flows are formed as opposed flows passing each other across the nozzle hole from each other.

### TECHNICAL FIELD

The present invention relates to a fuel injection valve which is provided on an internal combustion engine and supplies fuel into a cylinder or an intake port.

### BACKGROUND ART

There is known a fuel injection valve which has at a tip portion of a nozzle body, a plurality of nozzle holes from each of which fuel is injected. In such fuel injection valves, there is known a fuel injection valve which increases a flow velocity of fuel flowing into an inlet of the nozzle hole to promote fuel atomization, by swirling the fuel in the nozzle body to rectify the flow of the fuel flowing into the inlet (see Patent Document 1). In addition, there are Patent Documents 2-6 as prior art references in relation to the present invention.

### CITATION LIST

### Patent Literature

Patent Document 1: JP-A-2002-054532
Patent Document 2: JP-A-2005-048604
Patent Document 3: JP-A-2002-349393
Patent Document 4: JP-A-2004-176690
Patent Document 5: JP-A-10-184489
Patent Document 6: JP-A-2005-188336

### SUMMARY OF INVENTION

### Technical Problem

As one way to promote atomization of fuel injected from fuel injection valves, there is a way that the fuel is made into thin film and made to be injected from the nozzle hole. The fuel injection valve of the patent document 1 promotes atomization of fuel by increasing flow velocity of fuel flowing into the inlet of the nozzle hole. Thus, the fuel injection valve of the patent document 1 does not take into consideration to make the fuel into a thin film in the nozzle hole.

In view of the foregoing, one object of the present invention is to provide a fuel injection valve capable of promoting atomization of fuel by thinning fuel injected from a nozzle hole.

### Solution to Problem

A fuel injection valve of the present invention comprises a nozzle body having at least one nozzle hole in a tip portion thereof, where fuel led into the nozzle body is injected from the nozzle hole, wherein the fuel injection valve comprises: a first fuel swirling device for swirling a part of the fuel in the nozzle body to generate a first swirl flow; and a second fuel swirling device for swirling at least a part of remaining fuel left in the nozzle body to generate a second swirl flow, wherein the first fuel swirling device and the second fuel swirling device are mounted in the nozzle body so that, as viewed in a direction of a center line of the nozzle hole, the first swirl flow is located on one side of an inlet opening of the nozzle hole, while the second swirl flow being located on the other side of the inlet opening of the nozzle hole, and the first swirl flow and the second swirl flow are formed as opposed flows passing each other across the nozzle hole from each other.

According to the fuel injection valve of the present invention, the first swirl flow which is generated on one side of an inlet opening of the nozzle hole and the second swirl flow which is generated on the other side of the inlet opening of the nozzle hole pass each other across the nozzle hole from each other. Thereby, it is possible to swirl the fuel flowing into the nozzle hole, in a predetermined direction by the two swirl flows. At this moment, since each swirl flows swirl the fuel flowing into the nozzle hole in the same direction, it is possible to generate the strong swirl flow in the nozzle hole. Thereby, since it is possible to apply a strong centrifugal force to the fuel in the nozzle hole, it is possible to migrate the fuel to an inner periphery face side of the nozzle hole by the centrifugal force while traveling to the downstream side. Accordingly, it is possible to promote thinning of the fuel in the nozzle hole. And, it is possible to promote atomization of the fuel injected from the nozzle hole.

In one embodiment of the fuel injection valve of the present invention, wherein the tip portion may be provided with a plurality of nozzle holes in such a way that the plurality of nozzle holes are aligned concyclically, the first fuel swirling device may be provided so that the first swirl flow is generated on a location closer to a center side than a location of the plurality of nozzle holes while swirling in a predetermined swirling direction, and the second fuel swirling device may be provided so that the second swirl flow travels in a same direction as the first swirl flow, while swirling in a direction opposite to the predetermined swirling direction, and is generated on a location closer to an outer periphery side than a location of the plurality of nozzle holes. In this case, it is possible to swirl the fuel flowing into the plurality of nozzle holes by the first swirl flow and the second swirl flow. Since the number of parts to be contained in the nozzle body can be decreased, it is possible to downsizing of the fuel injection valve.

In one embodiment of the fuel injection valve of the present invention, may further comprise, a partition wall which separates an inside of the nozzle body into a first fuel passage and a second fuel passage so as to be merged at the inlet opening of the nozzle hole, wherein the first fuel swirling device may be arranged in the first fuel passage, and the second fuel swirling device may be arranged in the second fuel passage. In this case, it is possible to prevent interference between the swirl flows while the swirl flows pass through in the fuel passages. Thereby, it is possible to make the first swirl flow and the second swirl flow stronger. Accordingly, since it is possible to make the swirl flow generating in the nozzle hole stronger, thinning of the fuel can be promote further.

In one embodiment of the fuel injection valve of the present invention, wherein the tip portion may be provided with a plurality of nozzle holes, a part of the nozzle holes may be arranged on a first circumference to form a first group of nozzle holes, while remains of the nozzle holes may be arranged on a second circumference coaxially with the first circumference and form a second group of nozzle holes at an outside of the first group of nozzle holes, the first fuel swirling device may be arranged so as to generate the first swirl flow on a center side of the first group of the nozzle holes by swirling first fuel as a part of the fuel led into the nozzle body in a predetermined swirling direction, and the second fuel swirling device may be arranged so as to generate the second swirl flow traveling in a same direction as the first swirl flow on an outer periphery side than the first group of nozzle holes and on a location closer to the center side than the second group of nozzle holes by swirling in a direction opposite to the predetermined swirling direction, second fuel as a part of remaining fuel in the nozzle body, wherein the fuel injection valve may further comprise: a third fuel swirling device for swirling in the predetermined swirling direction, remaining fuel of the fuel led into the nozzle body except the first fuel and the second fuel to generate on an outside of the second swirl flow, a third swirl flow traveling in the same direction as the first swirl flow; a first partition wall for separating the inside of the nozzle body into a first fuel passage where the first swirl flow is generated and remaining space; and a second partition wall for separating the remaining space in the nozzle body into a second fuel passage where the second swirl flow is generated and a third fuel passage where the third swirl flow is generated. In the present embodiment, it is possible to swirl the fuel flowing into the nozzle holes of the first group of nozzle holes by the first swirl flow and the second swirl flow. And, it is possible to swirl the fuel flowing into the nozzle holes of the second group of nozzle holes by the second swirl flow and the third swirl flow. Thereby, since it is possible to generate the swirl flow in each nozzle hole, it is possible to promote thinning of the fuel in each nozzle hole. And, in the present embodiment, since the plurality of nozzle holes providing at the tip portion of the nozzle body are separated to the first group of the nozzle hole and the second group of the nozzle hole, the distance between the nozzle holes can be increased, compared to a case that all nozzle holes are arranged on one circumference. Thereby, it is possible to suppress the collision of the fuel injected from the nozzle hole with the neighbor fuel thereof. Accordingly, fuel atomization can be promoted while increasing the amount of fuel that can be injected once by increasing the number of nozzle holes.

In one embodiment of the fuel injection valve of the present invention which is separated into a plurality of fuel passages in the nozzle body by the partition wall, may further comprise, a valving element for leading the fuel into the nozzle body by lifting the valving element from a state that the valve element is contacted to a valve seat formed on the nozzle body, the valving element being provided on an upstream side of the nozzle body, and a flow passage area changing device for changing flow passage area of at least either one of the first fuel passage and the second fuel passage depending on lift amount of the valving element. And in this embodiment, wherein, the flow passage area changing device may increase the flow passage area of at least one of the first fuel passage and the second fuel passage with increase in the lift amount of the valving element. The amount of fuel flowing into the nozzle body, is few shortly after the valving element lifts from the valve seat. In the fuel injection valve of the present embodiment, since the flow passage area of the fuel passage is decreased in such a case, it is possible to increase the flow velocity of the fuel, and to generate the strong swirl flow. Meanwhile, the amount of fuel flowing into the nozzle body is increased as the lift amount of the valving element is increased. In the fuel injection valve of the present embodiment, since the flow passage area of the fuel passage is increased in such a case, it is possible to decrease the pressure loss of the fuel passage. Thereby, since it is possible to prevent that the fuel flow velocity is decreased unnecessary, the strong swirl flow can be generated. In the fuel injection valve of the present embodiment, since the flow passage area is changed according to the amount of fuel which flows into the nozzle body like this, it is possible to generate the strong swirl flow of any amount of fuel. Thereby, thinning of the fuel can be promoted by generating the strong swirl flow in the nozzle hole.

Furthermore, the first fuel passage may be formed cylindrically, and to the first fuel passage, a first helical gear may be provided as the flow passage area changing device, the first helical gear being provided coaxially with the first fuel passage and rotatably around an axis of the first fuel passage, and a second helical gear may be provided as the first fuel swirling device, the second helical gear being provided coaxially and overlappedly with the first helical gear to be fixed in the first fuel passage, the second helical gear having a same shape of the first helical gear, wherein the fuel injection valve may further comprise a motion conversion mechanism which converts a linear motion of the valving element to a rotation motion of the first helical gear. In this case, by adjusting a overlapping between the teeth of the first helical gear and the teeth of the second helical gear by rotating the first helical gear, it is possible to change the flow passage area of the fuel passage. Since the valving element and the first helical gear can be interlocked, it is possible to rotate the first helical gear according to the lift amount of the valving element. thereby, it is possible to change the flow passage area of the fuel passage according to the lift amount of the valving element.

In one embodiment of the fuel injection valve of the present invention which is separated into a plurality of fuel passages in the nozzle body by the partition wall, wherein each of the fuel passages may be formed cylindrically, and each of the fuel swirling devices may be arranged in the nozzle body so that values are equaled with each other, each of the values being obtained by dividing a radius of the fuel passage where the generated swirl flow flows by a distance from the fuel swirling device which generates the swirl flow to the nozzle hole. The swirl flow is slowed down by friction generating between a surface forming the fuel passage and the swirl flow. It is considered that the friction loss is proportional to a distance where the swirl flow swirled (referred to as swirl distance, hereinafter). The swirl distance can be calculated by multiplying the number of times which the swirl flow swirls from the fuel swirling device to the inlet opening of the nozzle hole (referred to as swirl times, hereinafter) by the length of the outer periphery of the fuel passage. The length of the outer periphery of the fuel passage is proportional to the radius of the fuel passage (referred to as swirl radius, hereinafter). It is considered that the swirl times is proportional to a value which is a value obtained by dividing a velocity of swirl flow in the direction of the center line of the fuel passage by the distance from the fuel swirling device to inlet opening of the nozzle hole (referred to as swirl section length, hereinafter). Here, assuming the velocities of the swirl flows in each fuel passage in the direction of the center line are made equal, it is considered that the swirl distance is proportional to a value which is a value obtained by dividing the swirl radius by the swirl section length. In the present embodiment, since each fuel swirling device is arranged, so that the values which are values obtained by dividing the swirl radius by the swirl section length of each fuel swirling device are make equal with each other, it is possible to make the friction loss of each swirl flow almost equal to each other. In this case, it is possible to even out the strength of the swirl flow located the one side of the nozzle hole and the strength of the swirl flow located the other side of the nozzle hole, it is possible to suppress the fuel flows into the nozzle hole while the fuel traveling toward the one side or the other side. Thereby, since the fuel can be rotated coaxially with the nozzle hole in the upstream side of the inlet opening of the nozzle hole, it is possible to generate the strong swirl flow in the nozzle hole. Accordingly, thinning of the fuel can be promoted further.

In one embodiment of the fuel injection valve of the present invention which is separated into a plurality of fuel passages in the nozzle body by the partition wall, may comprise a friction reducing device which is provided on at least either one of an inner peripheral surface of the nozzle body and a surface of the partition wall arranged in the nozzle body, for reducing friction between those surfaces and the fuel. In this case, since it is possible to suppress decreasing the flow velocity of the swirl flow by the friction loss, unnecessary loss of the kinetic energy of the swirl flow can be suppressed when the swirl flow passes through in the fuel passage. Thereby, since it is possible to lead the strong swirl flow to around the inlet opening of the nozzle hole, it is possible to generate the strong swirl flow in the nozzle hole. Accordingly, thinning of the fuel can be promoted.

In this embodiment, the friction reducing device may be a plurality of rollers which are arranged so as to be capable of rotating in a direction where the fuel swirls. As well known, friction force of rolling friction at the moment when the rollers are rotated by the fuel is smaller than friction force of sliding friction to be generated between a surface and the fuel. Thereby, by providing the rollers on the inner peripheral surface of the nozzle body and the surface of the partition wall, it is possible to decrease the friction which is generated between the fuel and the surfaces.

In one embodiment of the fuel injection valve of the present invention which is separated into a plurality of fuel passages in the nozzle body by the partition wall, wherein, the partition wall in the nozzle body may have a taper portion which is spread to the outer periphery side, and is provided on an end portion of a downstream side of the flow of the fuel, the tip portion of the nozzle body may be provided with an inclined face which is inclined so as to be perpendicular to an extending direction of the taper portion, and the nozzle hole may be arranged on the inclined face. In this case, since the nozzle hole is arranged on the inclined face of the tip portion, it is possible to inject the fuel inclined to outer periphery side with respect to the center line of the nozzle body. Thereby, it is possible to suppress that the fuel which is injected from the nozzle hole collides against the fuel which is injected from the adjoining nozzle hole. Accordingly, it is possible to increase the number of the nozzle holes which is capable of forming on the tip portion. The taper portion arranged on the partition wall, is formed so that an extending direction of the taper portion is perpendicular to the inclined face. Thereby, the swirl flow travels toward a perpendicular direction with respect to the inclined face. In this case, on the inclined face, it is possible to be opposed each swirl flow generated in each fuel passage. Thereby, the fuel flowing into the nozzle holes is swirled by the swirl flows. Accordingly, it is possible to generate the swirl flow in the nozzle hole. According to the fuel injection valve of the present embodiment, thinning of the fuel can be promoted while the amount of the fuel possible to be injected at once is making increase by increasing the number of nozzle holes.

In one embodiment of the fuel injection valve of the present invention, wherein, a helical gear which has teeth inclined with respect to a center line, may be provided serving as at least either one of the first fuel swirling device and the second fuel swirling device. As well known, the helical gear is on shelves as a standard product. Thereby, by using the helical gear serving as the fuel swirling device, it is possible to reduce a cost.

In one embodiment of the fuel injection valve of the present invention, wherein, a plurality of helical gears, each of which has teeth which are inclined with respect to the center line at different inclination angles from each other, may be provided as at least either one of the first fuel swirling device and the second fuel swirling device, and the plurality of helical gears may be stacked in such a way that, as the helical gear is located at further downstream side, the inclination angle becomes larger. By arranging the helical gears so that the inclination angle becomes larger as the helical gear is located at further downstream side, it is possible to change the fuel flow direction smoothly to the circumferential direction, compared to a case the fuel flow direction is changed by only one helical gear. Thereby, it is possible to swirl the fuel while suppressing a decrease in the flow velocity.

In one embodiment of the fuel injection valve of the present invention, wherein, a cutout portion, that is hollowed outward in a radial direction, may be formed on an inner peripheral surface of the nozzle hole and along the center line of the nozzle hole. In the present embodiment, a part of the fuel of the swirl flow generated in the nozzle hole flows into the cutout portion, and a swirl is generated in the cutout portion. When the swirl is generated in the cutout portion, a pressure in the cutout portion becomes lower than a pressure in the nozzle hole. Thereby, it is possible to generate a suction power which sucks the fuel of the swirl flow in the nozzle hole into the cutout portion. Hence, it is possible to migrate the fuel to the inner periphery face by the centrifugal force and the suction power. Accordingly, thinning of the fuel can be promote further.

In this embodiment, a cross-section shape of the cutout portion may be a circle. In this case, it is possible to swirl the fuel in the cutout portion smoothly. Thereby, the suction power can become strong by generating the strong swirl flow in the cutout portion. Accordingly, thinning of the fuel can be promote further.

### BRIEF DESCRIPTION OF DRAWINGS

FIG. 1 is a view showing a fuel injection valve according to a first embodiment of the present invention.

FIG. 2 is an enlarged view showing a cross-section of a portion of the fuel injection valve enclosed by broken line in FIG. 1.

FIG. 3 is a cross section view of the fuel injection valve taken along the line in FIG. 2.

FIG. 4 is a cross section view of the fuel injection valve taken along the line IV-IV in FIG. 2.

FIG. 5 is a cross section view of the fuel injection valve taken along the line V-V in FIG. 2.

FIG. 6 is a cross section view of the fuel injection valve taken along the line V1-V1 in FIG. 2.

FIG. 7 is a cross section view of the fuel injection valve taken along the line VII-VII in FIG. 2.

FIG. 8 is a perspective view showing an inner structure of a nozzle body.

FIG. 9 is an enlarged view showing a portion enclosed by broken line in FIG. 7.

FIG. 10 is an enlarged view showing a second swirl member of the fuel injection valve according to a second embodiment of the present invention.

FIG. 11 is an enlarged view showing a nozzle hole of the fuel injection valve according to a third embodiment of the present invention.

FIG. 12 is an enlarged view showing a portion enclosed by broken line in FIG. 11.

FIG. 13 is an enlarged view showing the nozzle hole of a variation of the fuel injection valve according to the third embodiment of the present invention.

FIG. 14 is an enlarged view showing a portion enclosed by broken line in FIG. 13.

FIG. 15 is a cross section view showing a swirl portion of the fuel injection valve according to a fourth embodiment of the present invention.

FIG. 16 is a cross section view of the fuel injection valve taken along the line XVI-XVI in FIG. 15.

FIG. 17 is a cross section view of the fuel injection valve taken along the line XVII-XVII in FIG. 15.

FIG. 18 is a cross section view of the fuel injection valve taken along the line XVIII-XVIII in FIG. 15.

FIG. 19 is a view showing the fuel injection valve viewed in a direction of an arrow XVIIII in FIG. 15.

FIG. 20 is a cross section view of the fuel injection valve taken along the line XX-XX in FIG. 19.

FIG. 21 is a cross section view showing the swirl portion of the fuel injection valve according to a fifth embodiment of the present invention.

FIG. 22 is a view showing the fuel injection valve viewed in a direction of an arrow XXII in FIG. 21.

FIG. 23 is a cross section view of the fuel injection valve taken along the line XXIII-XXIII in FIG. 22.

FIG. 24 is a cross section view showing the swirl portion of the fuel injection valve according to a sixth embodiment of the present invention.

FIG. 25 is a cross section view showing the swirl portion of the fuel injection valve according to a seventh embodiment of the present invention.

FIG. 26 is a cross section view of the fuel injection valve taken along the line XXVI-XXVI in FIG. 25.

FIG. 27 is a development view showing a portion enclosed by broken line in FIG. 26.

FIG. 28 is a cross section view showing the swirl portion of a variation of the fuel injection valve according to a seventh embodiment of the present invention.

FIG. 29 is a cross section view of the fuel injection valve taken along the line XVIIII-XVIIII in FIG. 28.

FIG. 30 is a development view showing a portion enclosed by broken line in FIG. 29.

FIG. 31 is a view showing the swirl portion of the fuel injection valve according to an eighth embodiment of the present invention.

FIG. 32 is an enlarged view showing a portion enclosed by solid line in FIG. 31.

FIG. 33 is a graph showing temporal variations of a lift amount of a needle and a flow passage area of a first fuel passage at a position where a first helical gear is located.

FIG. 34 shows a state of a first helical gear and the second helical gear when the needle is full-closed.

FIG. 35 shows a state of the first helical gear and the second helical gear when the needle is lifting.

FIG. 36 shows a state of the first helical gear and the second helical gear when the needle is full-opened.

### DESCRIPTION OF EMBODIMENTS

### First Embodiment

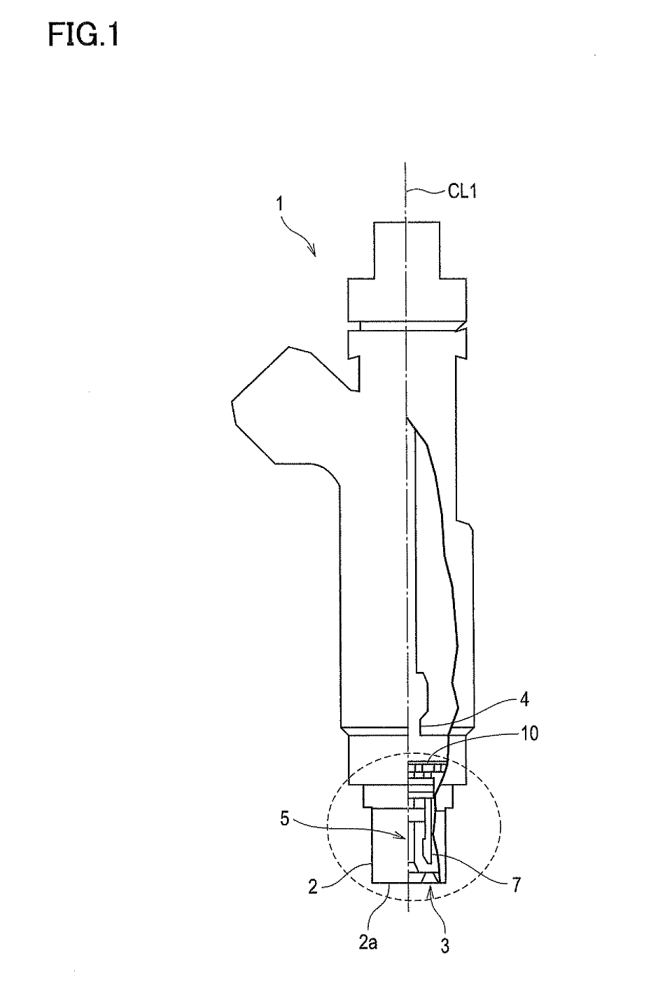

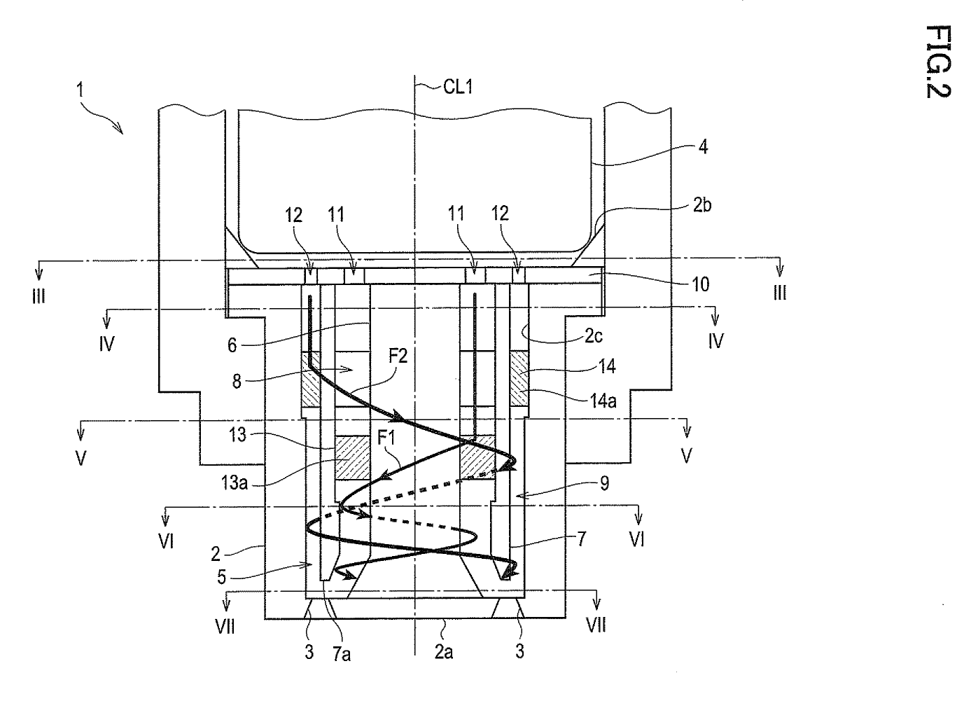

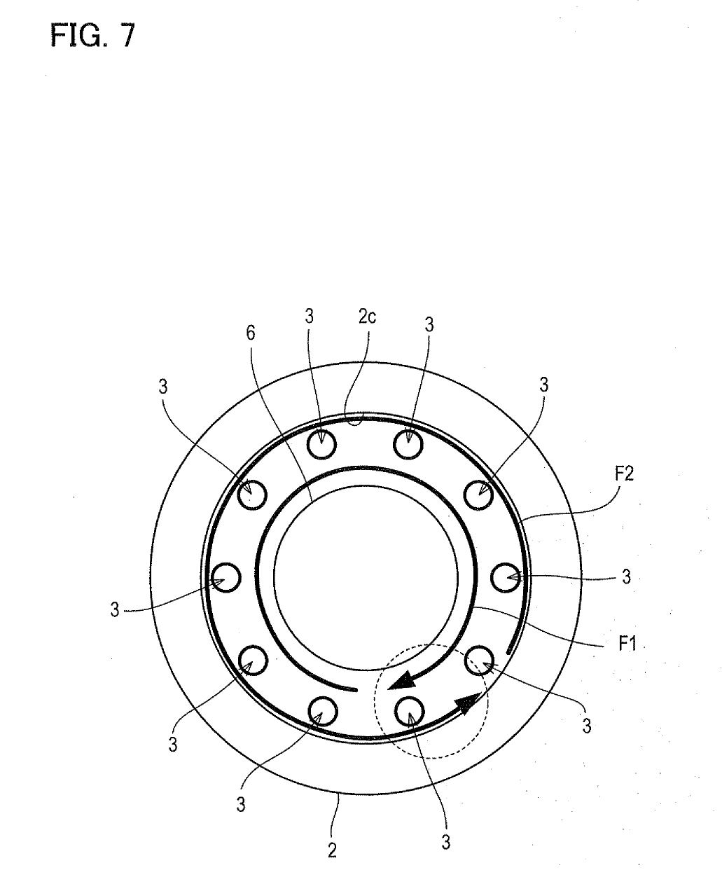

FIG. 1 shows a fuel injection valve according to a first embodiment of the present invention. In FIG. 1, a part of the fuel injection valve is shown in section. The fuel injection valve 1 is configured as a fuel injection valve which is provided on a port-injection internal combustion engine which injects fuel into an intake port. Fuel which is maintained at a prescribed pressure in an accumulation pressure room (not shown) is supplied to the fuel injection valve 1. FIG. 2 is an enlarged view showing a cross section of a portion enclosed by broken line in FIG. 1. As shown in FIG. 2, the fuel injection valve 1 comprises a nozzle body 2 having ten nozzle holes 3 (see FIG. 7) at a tip portion 2a and a needle 4 serving as a valving element. The needle 4 is accommodated in the nozzle body 2 so as to be movable in a direction of a center line CL1 of the fuel injection valve 1. The nozzle body 2 is provided with a valve seat 2b capable of seating the needle 4. The needle 4 is biased by a spring (not shown) so as to contact the valve seat 2b. Inflow of fuel to downstream side further than the valve seat 2b is inhibited when the needle 4 is seated on the valve seat 2b. Meanwhile, the needle 4 separates from the valve seat 2b when the needle 4 is driven to the upper direction of FIG. 2 by an electrical magnet (not shown) provided in the fuel injection valve 1, and fuel is supplied to the downstream side further than the valve seat 2b and is injected from each nozzle hole 3. In the fuel injection valve 1, fuel flows from the upper side toward the lower side in FIG. 2. Hereinafter, the upper side of the fuel injection valve 1 in FIG. 2 is referred to as an upstream side, and the lower side of the fuel injection valve 1 in FIG. 2 is referred to as a downstream side.

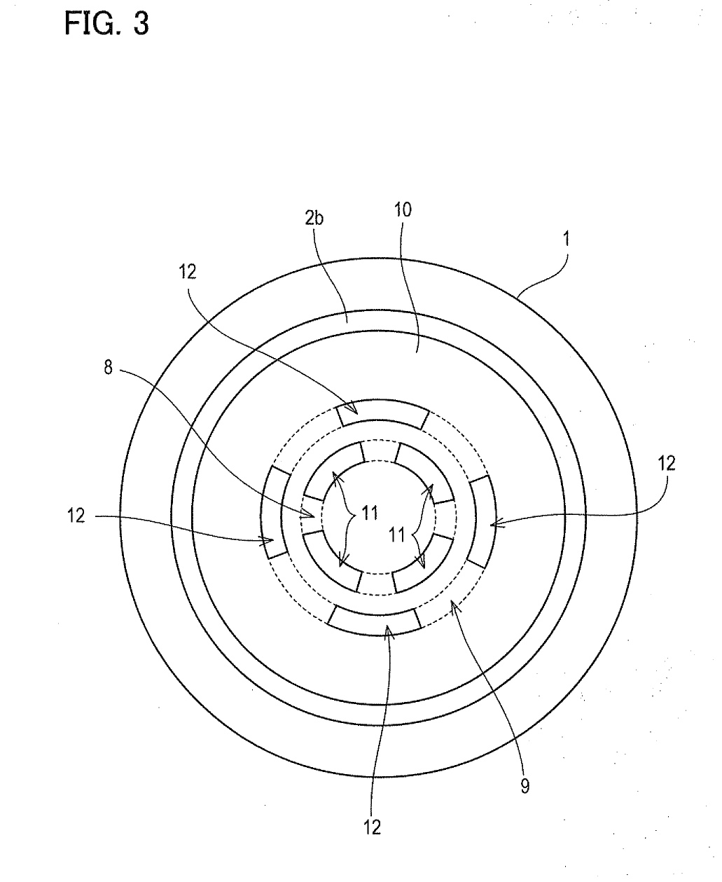

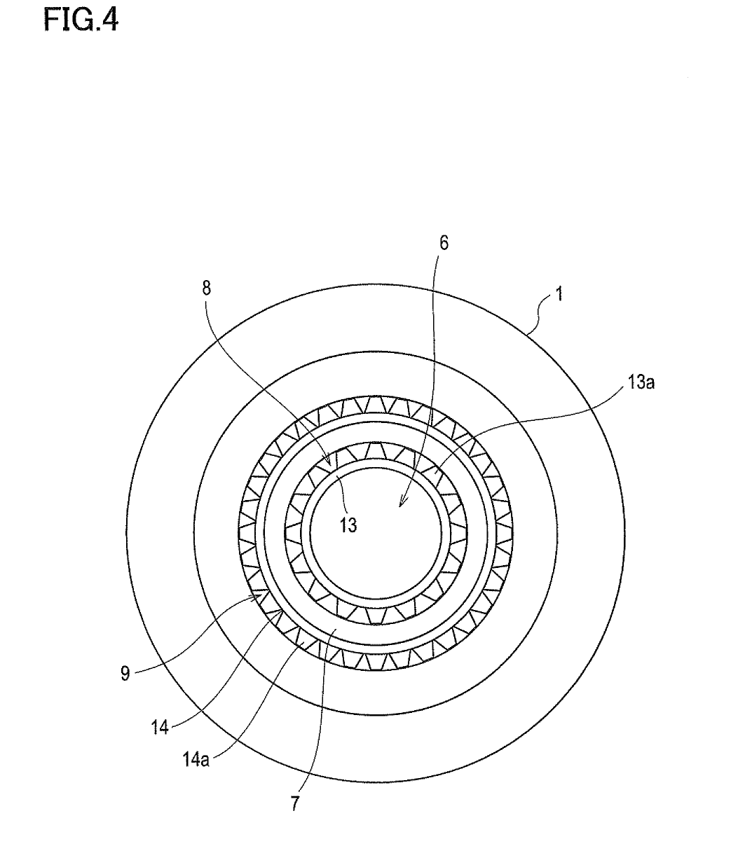

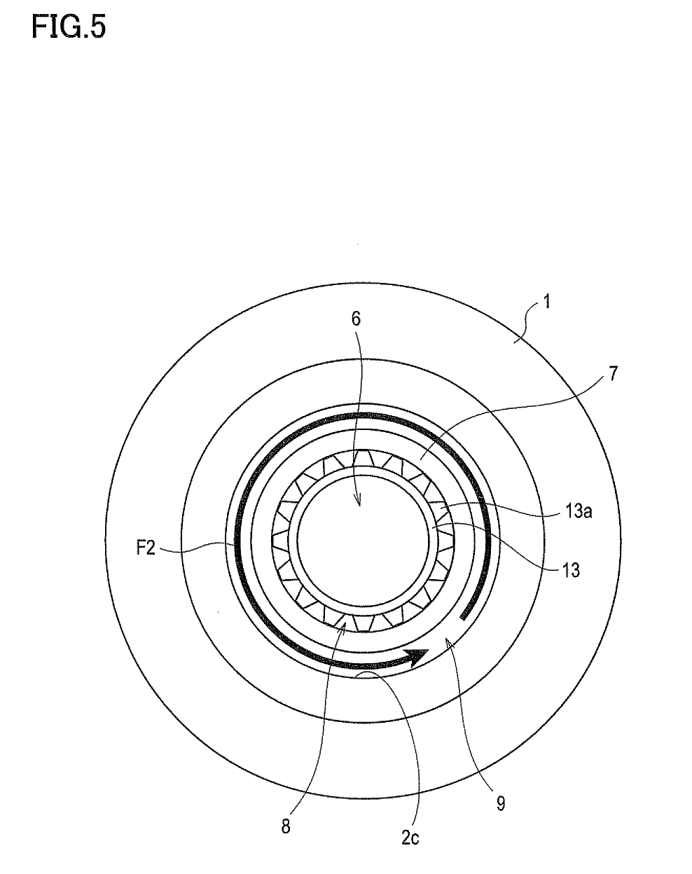

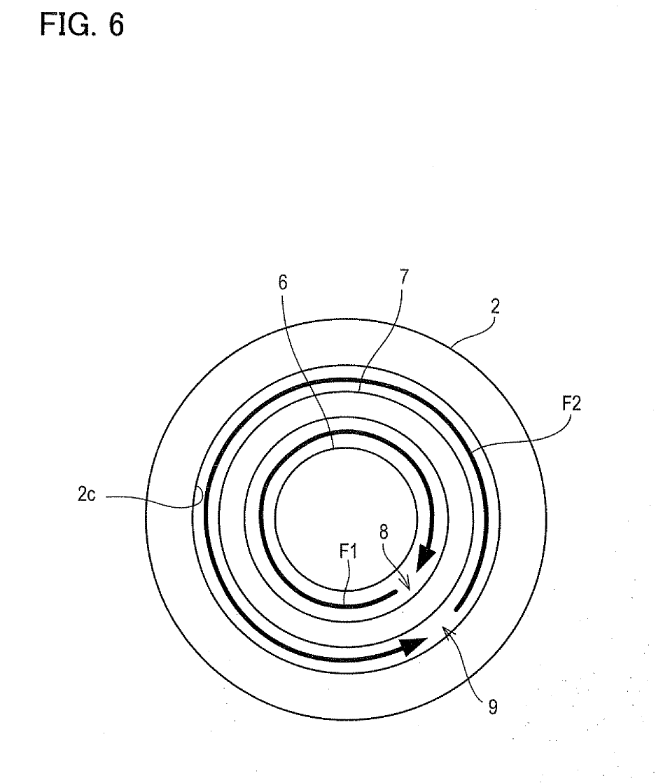

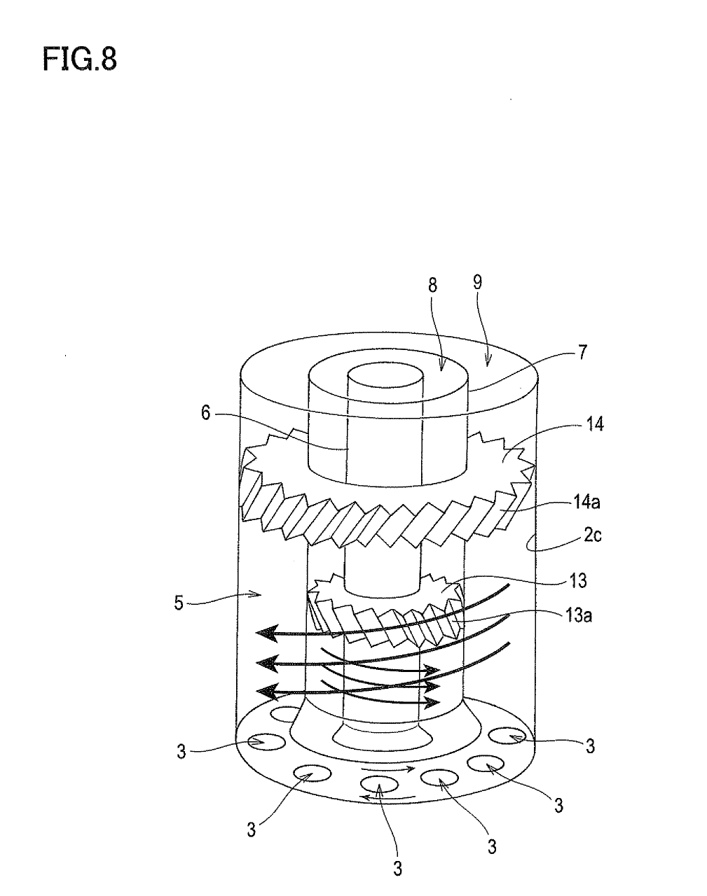

An inner structure of the nozzle body 2 will be described with reference to FIGS. 2 to 8. FIG. 3 shows a cross section of the fuel injection valve 1 taken along the line in FIG. 2. FIG. 4 shows a cross section of the fuel injection valve 1 taken along the line IV-IV in FIG. 2. FIG. 5 shows a cross section of the fuel injection valve 1 taken along the line V-V in FIG. 2. FIG. 6 shows a cross section of the fuel injection valve 1 taken along the line V1-V1 in FIG. 2. FIG. 7 shows a cross section of the fuel injection valve 1 taken along the line VII-VII in FIG. 2. FIG. 8 shows a perspective view of the inner structure of the nozzle body 2. As shown in FIG. 7, the ten nozzle holes 3 are arranged to be aligned concyclically having the center line CL1 as the center thereof at regular intervals.

As shown in FIG. 2, the nozzle body 2 is provided with a swirl portion 5 for swirling fuel which has passed between the valve seat 2b and the needle 4. The swirl portion 5 is provided with a column-shaped center column 6 and a cylindrical partition wall 7 which is arranged between the center column 6 and an inner peripheral surface 2c of the nozzle body 2. As shown in this figure, the center column 6 is arranged on the center line CL1 of the fuel injection valve 1. Further, the center column 6 is configured in such a way that an outer peripheral surface thereof is located at location closer to the center side than a location of the ten needle holes 3 and a downstream portion of the center column 6 is gradually spread toward outside. As shown in FIGS. 3 to 6, the partition wall 7 is arranged so as to form coaxially, a first fuel passage 8 and a second fuel passage 9 between the outer peripheral surface of the center column 6 and the inner peripheral surface 2c of the nozzle body 2. As shown in those figures, the first fuel passage 8 is formed between the center column 6 and the partition wall 7, and the second fuel passage 9 is formed between the partition wall 7 and the nozzle body 2. As shown in FIG. 2, the partition wall 7 is arranged so as to overlap the ten nozzle holes 3 viewing the nozzle body 2 in a direction of the center line CL1. Therefore, the first fuel passage 8 is formed at a location closer to the center than a location of the ten nozzle holes 3, and the second fuel passage 9 is formed outer peripheral side than the ten nozzle holes 3. The partition wall 7 is arranged so that a downstream end portion 7a is not contacted with the tip portion 2a. Thereby, the first fuel passage 8 and the second fuel passage 9 are merged around an inlet opening 3a of the nozzle hole 3.

A distribution plate 10 is provided on an upstream end of the swirl portion 5 so as to distribute fuel flowing into the swirl portion 5 to the first fuel passage 8 and the second fuel passage 9. As shown in FIG. 3, the distribution plate 10 is provided with a first inlet opening 11 for leading the fuel to the first fuel passage 8 and a second inlet opening 12 for leading the fuel to the second fuel passage 9. As shown in this figure, there are provided four of the first inlet openings 11 which are aligned concyclically at regular intervals, and there are provided four of the second inlet openings 12 which are aligned concyclically at regular intervals. Moreover, as shown in this figure, each second inlet opening 12 is aligned so as to locate between the first inlet openings 11, in order to avoid getting into line with the first inlet opening 11 in a radial direction. That is, the first inlet opening 11 and the second inlet opening 12 are arranged alternately in a circumferential direction.

The first fuel passage 8 is provided with a first swirl member 13 serving as a first fuel swirling device swirling in the clockwise, fuel flowing into the first fuel passage 8. The second fuel passage 9 is provided with a second swirl member 14 serving as a second fuel swirling device swirling in the counterclockwise, fuel flowing into the second fuel passage 9. As shown in FIG. 4, each swirl member 13, 14 has a plurality of teeth 13a, 14a aligning along the whole circumference of the outer periphery at regular intervals. As shown in FIGS. 2 and 8, each tooth 13a is inclined in the same direction with respect to a center line of the first swirl member 13 at the same angle, and each tooth 14a is inclined in the same direction with respect to a center line of the second swirl member 14 at the same angle. As each swirl member 13, 14, for example, a publicly known helical gear is used. The first swirl member 13 and the second swirl member 14 are arranged so that the teeth 13a and the teeth 14a are inclined in opposite directions to each other. The first swirl member 13 is fixed by being pressed into space between the center column 6 and the partition wall 7. The second swirl member 14 is fixed by being pressed into space between the partition wall 7 and the nozzle body 2.

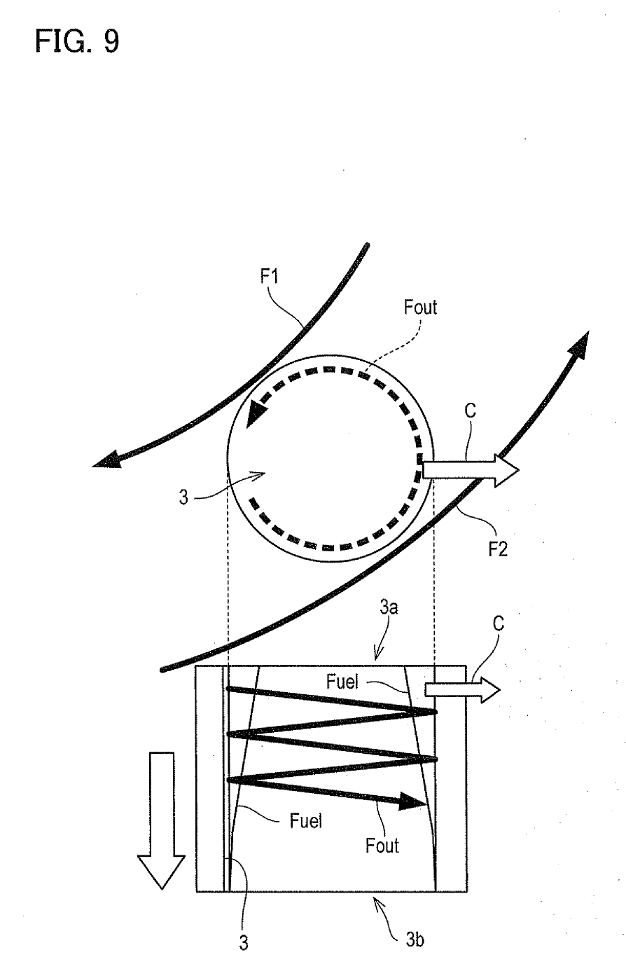

Next, flow of fuel in the swirl portion 5 will be described with reference to FIGS. 2 to 9. An upper figure in FIG. 9 is an enlarged view showing a portion enclosed by broken line in FIG. 7. A lower figure in FIG. 9 shows a state of fuel in the nozzle hole 3. In the fuel injection valve 1, when the needle 4 is driven upward in FIG. 2 and is separated from the valve seat 2b, fuel flows from the outer periphery toward the center along the distribution plate 10 as an example shown in FIG. 3. A part of the fuel flows into the second inlet opening 12 and is led to the second fuel passage 9. Remaining fuel flows into the first inlet opening 11 and is led to the first fuel passage 8. The fuel which is led to the first fuel passage 8 passes through the first swirl member 13. At this moment, as shown in FIG. 2, the first swirl member 13 generates a first swirl flow F1 by swirling the fuel in the clockwise. The fuel which is led to the second fuel passage 9 passes through the second swirl member 14. At this moment, the second swirl member 14 generates a second swirl flow F2 by swirling the fuel in the counterclockwise. Thereby, as shown in FIG. 6, it is possible to generate a pair of swirl flows swirling in opposite directions to each other in the first fuel passage 8 and the second fuel passage 9.

As described above, the first fuel passage 8 and the second fuel passage 9 are merged around the inlet opening 3a of the nozzle hole 3. Thereby, as shown in FIG. 7, the pair of swirl flows F1, F2 becomes around the inlet opening 3a of the nozzle hole 3, opposed flows passing each other across the nozzle hole 3 from each other. The fuel of each swirl flow F1, F2 flows into each nozzle hole 3 gradually. In this case, as shown in the upper figure in FIG. 9, each of the pair of swirl flows F1, F2 imparts rotational motion in a counterclockwise direction to the fuel flowing into the inlet opening 3a of the nozzle hole 3. Thereby, it is possible to generate a counterclockwise swirl flow Fout in the nozzle hole 3. By swirling the fuel in the nozzle hole 3 in this manner, as shown the lower figure in FIG. 9, it is possible to migrate the fuel Fuel gradually to an outside in the radial direction by a centrifugal force C. Thus, as shown in this figure, the thickness of the fuel is decreased gradually as the fuel travels toward an outlet opening 3b of the nozzle hole 3. The fuel is shaped into a thin film, and is injected from the nozzle hole 3.

According to the fuel injection valve 1 of the first embodiment, since the rotational motion in the counterclockwise direction is imparted to the fuel flowing into the nozzle hole 3 by each of the first swirl flow F1 and the second swirl flow F2, it is possible to generate a strong swirl flow Fout in the nozzle hole 3. Thereby, since it is possible to give a strong centrifugal force C to the fuel Fuel in the nozzle hole 3, thinning of the fuel Fuel can be promoted. When the thin film shaped fuel is injected from the nozzle hole 3 to the outward, the fuel spreads quickly. Accordingly, it is possible to promote fuel atomization.

Since the first swirl flow F1 and the second swirl flow F2 are separated by the partition wall 7 until they reach around the inlet opening 3a of the nozzle hole 3, it is possible to prevent interference between the swirl flows F1, F2. Thereby, decrease of rotational energy of the swirl flows F1, F2 are suppressed, and it is possible to generate the strong opposite swirl flow around the inlet opening 3a of the nozzle hole 3.

The first inlet opening 11 and the second inlet opening 12 are arranged alternately in a circumferential direction in the distribution plate 10. By arranging the inlet openings 11, 12 in this manner, it is possible to flow into the first inlet opening 11, almost half of the fuel which flows from the outer periphery toward the center on the distribution plate 10. Thereby, the amount of fuel led into the first fuel passage 8 and the amount of fuel led into the second fuel passage 9 can be made almost the same.

It is possible to use a publicly known helical gear as the first swirl member 13 and the second swirl member 14. As well known, since the helical gear is on shelves as a standard product, it is unnecessary to redesign each swirl member 13, 14 newly. Thereby, it is possible to reduce a cost.

### Second Embodiment

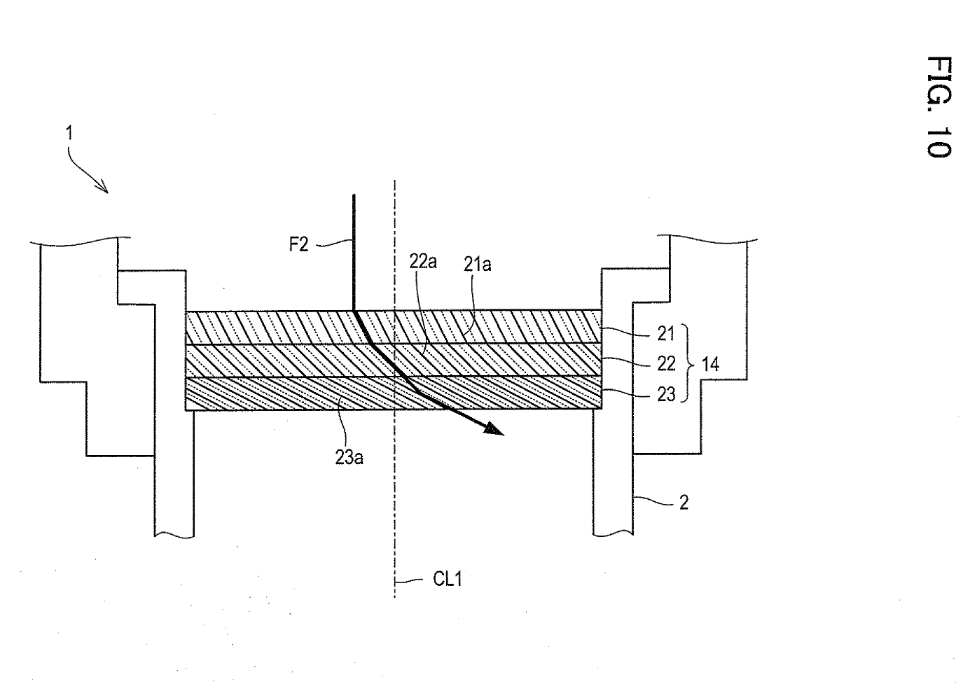

A fuel injection valve according to a second embodiment of the present invention will be described with reference to FIG. 10. FIG. 10 is an enlarged view showing a second swirl member of the fuel injection valve of the present embodiment. The second embodiment is different from the first embodiment in that each swirl member 13, 14 is configured by a plurality of helical gears, and the rest is the same as the first embodiment. Therefore, the same components as those in the first embodiment are denoted by the same reference numeral, and descriptions thereof will be omitted. As shown in FIG. 10, the second swirl member 14 is configured by three helical gears 21, 22, 23. The helical gears 21-23 have the same number of teeth 21a, 22a, 23a respectively. Each tooth 21a, 22a, 23a is arranged so as to be twisted in the same direction around the center line CL1. The helical gear 22 and the helical gear 23 are arranged for each of the teeth 22a, 23a to be aligned with teeth of the helical gear which is arranged on the upstream side. And, each helical gear 21-23 is arranged so that an inclination angle (sometimes referred to as helical angle, hereinafter) of tooth 21a, 22a, 23a with respect to the center line CL gets gradually larger as being located on further downstream. In this case, as shown in FIG. 10, the fuel F2 changes the flow direction thereof gradually in the circumferential direction each time when the fuel F2 passes through each helical gear 21-23. Although it is not shown, like the second swirl member 14, the first swirl member 13 is configured by also three helical gears. With respect to each of the helical gears in the first swirl member 13, the twisted direction of the teeth of the helical gear is opposite to the twisted direction in the second swirl member 14.

According to the fuel injection valve of the second embodiment, since the second swirl member 14 is configured by such three helical gears 21-23, it is possible to gradually change a flow direction of the fuel in the circumferential direction. Thereby, it is possible to reduce a pressure loss, compared to a case the flow direction of fuel is changed by only one helical gear. Accordingly, since it is possible to swirl the fuel almost without reducing the flow velocity of the fuel, it is possible to generate the strong second swirl flow F2. Since the first swirl member 13 is also configured in the same way, it is possible to generate the strong first swirl flow F1. In this case, since it is possible to generate the strong swirl flow Fout in the nozzle hole 3, thinning of the fuel can be promoted further. The number of the helical gears which configures each swirl member is not limited to three. The number of the helical gears may be two or, four or more.

### Third Embodiment

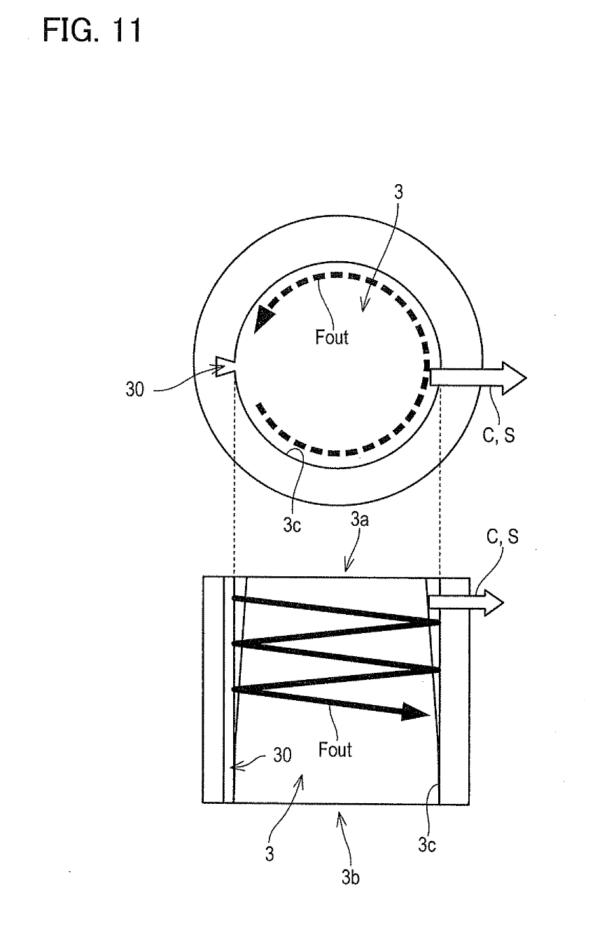

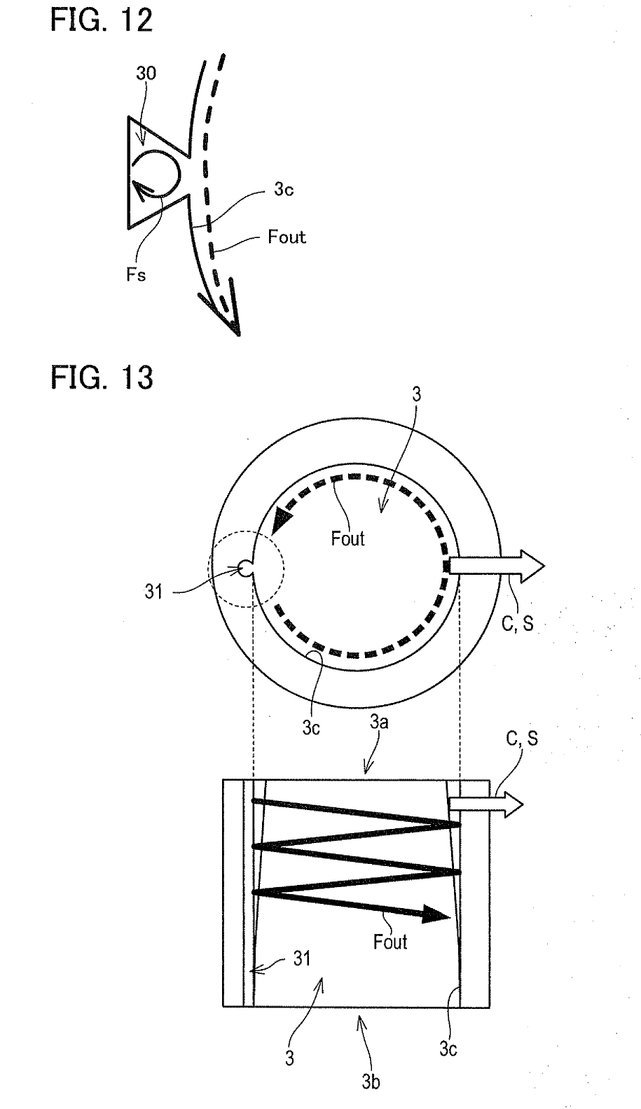

A fuel injection valve according to a third embodiment of the present invention will be described with reference to FIG. 11 and FIG. 12. FIG. 11 is an enlarged view showing a nozzle hole 3 of the fuel injection valve of the present embodiment. An upper figure in FIG. 11 is a view showing the nozzle hole 3 viewed from the inlet opening 3a side. A lower figure in FIG. 11 is a cross section view of the nozzle hole 3. FIG. 12 is an enlarged view showing a portion enclosed by broken line in FIG. 11. As shown in FIG. 11, in the present embodiment, the nozzle hole 3 is provided with a cutout portion 30. Since the rest of the present embodiment is the same as that of the first embodiment, an illustration thereof is omitted. The cutout portion 30 is formed so as to hollow outward in the radial direction from an inner periphery face 3c of the nozzle hole 3. The cutout portion 30 is formed so that the interior space is more spacious than the inlet. As shown in the lower figure in FIG. 11, the cutout portion 30 is formed so as to extend straight from the inlet opening 3a toward the outlet opening 3b. In this case, when the swirl flow Fout is generated in the nozzle hole 3, a part of the fuel of the swirl flow Fout flows into the cutout portion 30 and a swirl Fs is generated, as shown in FIG. 12. When the swirl Fs is generated in the cutout portion 30 in this manner, a pressure in the cutout portion 30 becomes lower than a pressure in the nozzle hole 3. Thereby, it is possible to generate a suction power S which sucks the fuel of the swirl flow Fout into the cutout portion 30.

According to the fuel injection valve of the present embodiment, the suction power S can be applied radially outward to the fuel Fuel in the nozzle hole 3. In this case, since it is possible to migrate the fuel Fuel to the inner periphery face 3c side by the centrifugal force C and the suction power S, thinning of the fuel Fuel can be promoted further. The number of the cutout portions 30 is not limited to one. More than two cutout portions 30 may be formed.

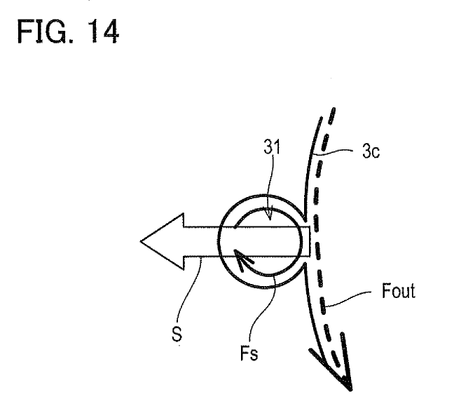

A variation of the fuel injection valve according to the third embodiment will be described with reference to FIG. 13 and FIG. 14. An upper figure in FIG. 13 is a view showing the nozzle hole 3 of the present variation viewed from the inlet opening 3a side. A lower figure in FIG. 13 is a cross section view of the nozzle hole 3. FIG. 14 is an enlarged view showing a portion enclosed by broken line in FIG. 13. As shown in the upper figure in FIG. 13, a cutout portion 31 of the present variation is formed so as to be circular in cross-section. In this variation, as shown in FIG. 14, it is possible to generate the swirl Fs by leading the fuel of the swirl flow Fout into the cutout portion 31. At this moment, since the cutout portion 31 is circular in cross-section, the fuel swirls smoothly in the cutout portion 31. Thereby, it is possible to generate the strong swirl Fs in the cutout portion 31. In this case, since the suction power S which is generated by the swirl Fs becomes strong, thinning of the fuel Fuel can be promoted further.

### Fourth Embodiment

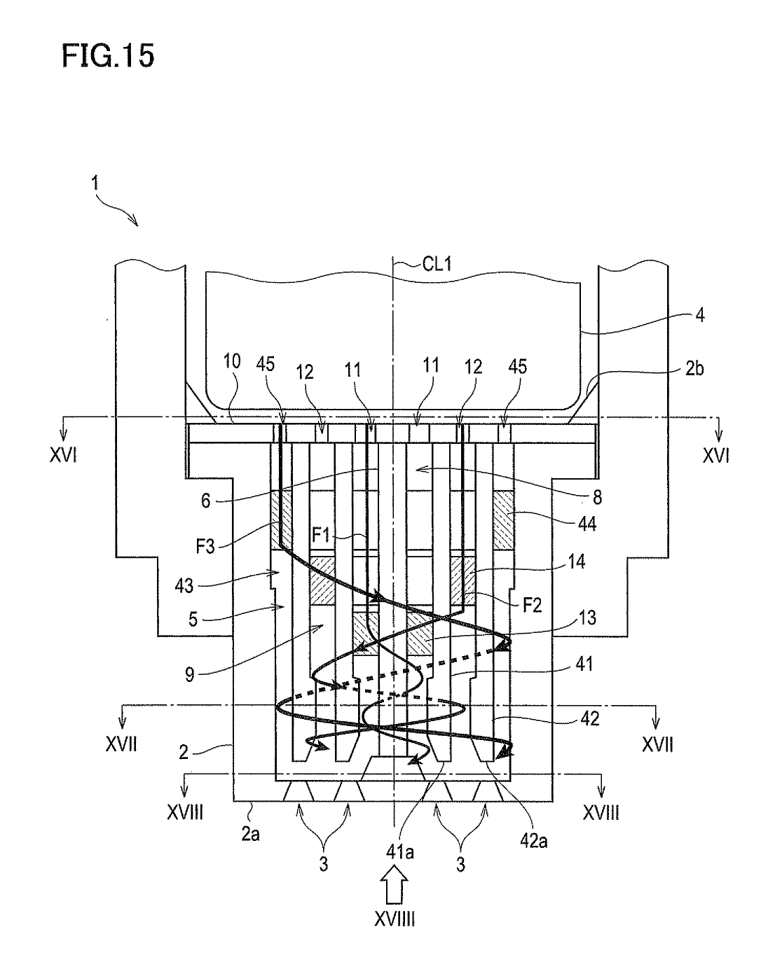

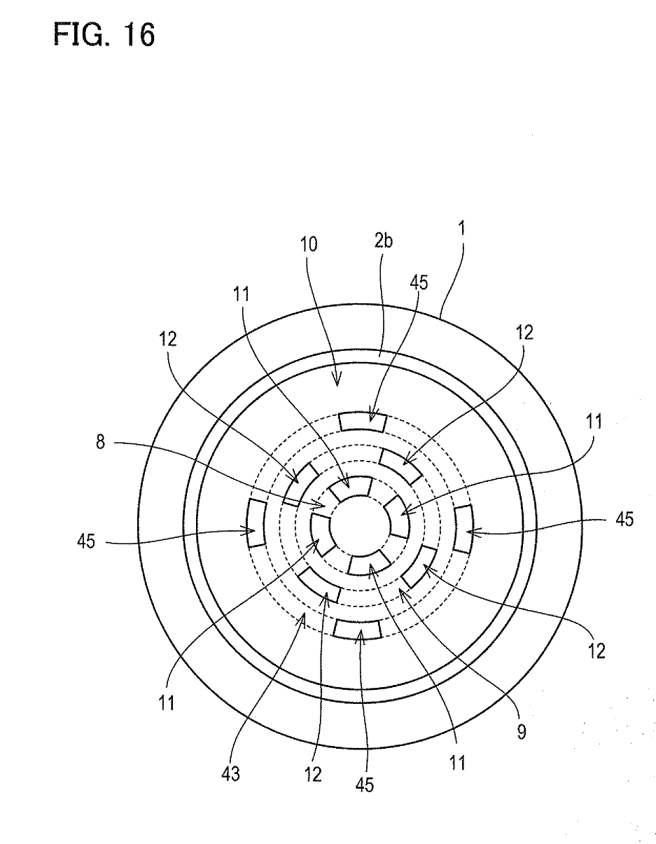

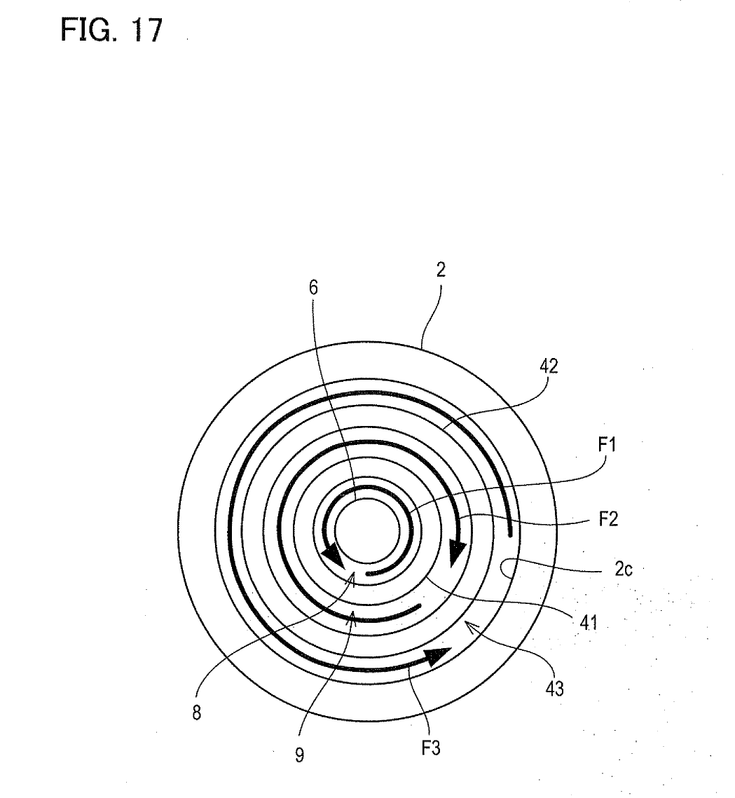

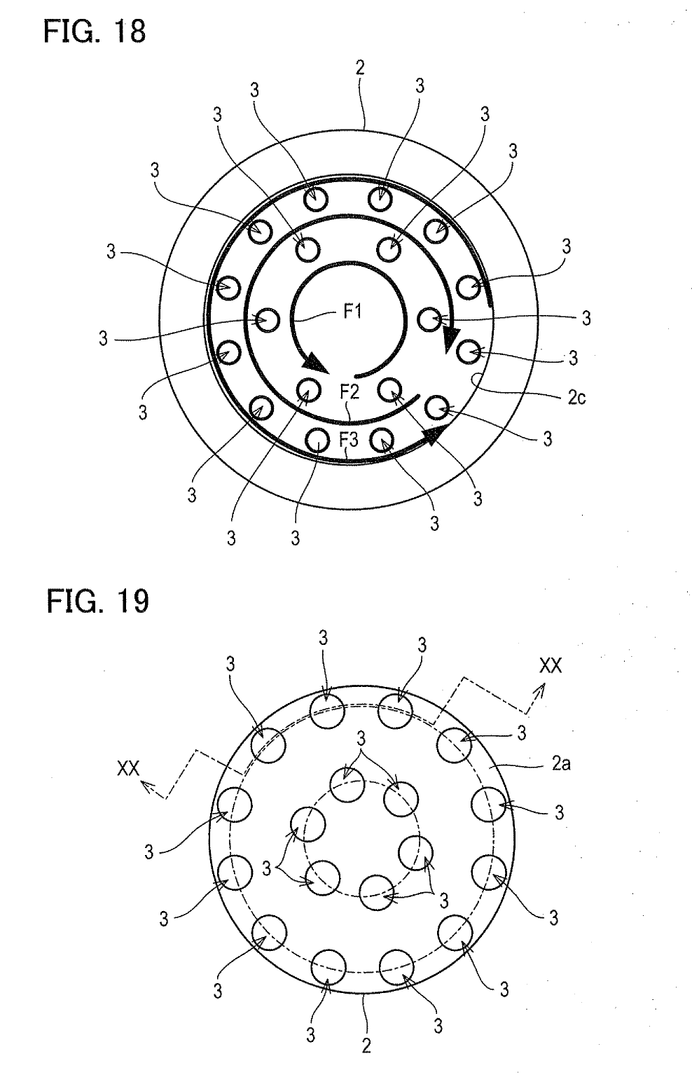

A fuel injection valve according to a fourth embodiment of the present invention will be described with reference to FIGS. 15 to 20, FIG. 15 is a cross section view showing the swirl portion 5 of the fuel injection valve 1 according to the present embodiment. FIG. 16 is a cross section view of the fuel injection valve 1 taken along the line XVI-XVI in FIG. 15. FIG. 17 is a cross section view of the fuel injection valve 1 taken along the line XVII-XVII in FIG. 15. FIG. 18 is a cross section view of the fuel injection valve 1 taken along the line XVIII-XVIII in FIG. 15. FIG. 19 is a view showing the fuel injection valve 1 viewed from a direction of an arrow XVIIII in FIG. 15. In the present embodiment, a structure of the fuel injection valve except a portion shown in FIG. 15 is the same as the first embodiment. In the present embodiment, the same components as those in the first embodiment are denoted by the same reference numeral, and descriptions thereof will be omitted.

As shown in FIG. 19, in the present embodiment, eighteen nozzle holes 3 are divided into two so as to be arranged on either one of two concentric circumferences. On one circumference, six nozzle holes 3 are arranged in the circumferential direction at regular intervals. Hereinafter, these six nozzle holes 3 are sometimes referred to as a first group of nozzle holes. On the other circumference, twelve nozzle holes 3 are arranged in the circumferential direction at regular intervals. Hereinafter, these twelve nozzle holes 3 are sometimes referred to as a second group of nozzle holes. As shown in this figure, the first group of nozzle holes is arranged the inside of the second group of nozzle holes.

As shown in FIG. 15, a first partition wall 41 and a second partition wall 42 are provided between the center column 6 and the inner peripheral surface 2c of the nozzle body 2. The center column 6, the first partition wall 41, and the second partition wall 42 are arranged coaxially. Each partition wall 41, 42 is formed cylindrically. In this case, the first fuel passage 8 is formed between the center column 6 and the first partition wall 41. The second fuel passage 9 is formed between the first partition wall 41 and the second partition wall 42. A third fuel passage 43 is formed between the second partition wall 42 and the nozzle body 2. The first partition wall 41 is arranged so as to be overlapped with the first group of nozzle holes as viewed the nozzle body 2 in the direction of the center line CL1. The second partition wall 42 is arranged so as to be overlapped with the second group of nozzle holes as viewed the nozzle body 2 in the direction of the center line CL1. Thereby, the first fuel passage 8 is arranged closer to the center side than the first group of nozzle holes. The second fuel passage 9 is arranged on a location closer to the outer periphery side than the first group of nozzle holes and closer to the center side than the second group of nozzle holes. The third fuel passage 43 is arranged on a location closer to the outer periphery side than the second group of nozzle holes. Each partition wall 41, 42 is arranged so that each downstream end portion 41a, 42a is not contacted with the tip portion 2a of the nozzle body 2. Thereby, these fuel passages 8, 9, 43 are merged into each other around the inlet opening 3a of the nozzle hole 3.

The first fuel passage 8 is provided with the first swirl member 13. The second fuel passage 9 is provided with the second swirl member 14. In the present embodiment, the first swirl member 13 is arranged so that the fuel is swirled counterclockwise. The second swirl member 14 is arranged so that the fuel is swirled clockwise. The third fuel passage 43 is provided with a third swirl member 44 serving as a third fuel swirling device. The third swirl member 44 is arranged so that the fuel flowing into the third fuel passage 43 is swirled counterclockwise. Thus, these swirl members 13, 14, 44 are arranged so that the fuels in the fuel passages next to each other are swirled in the opposite direction to each other. As the third swirl member 44, for example, a publicly known helical gear is used. The third swirl member 44 is fixed by being pressed into space between the second partition wall 42 and the nozzle body 2.

As shown in FIG. 16, the distribution plate 10 is provided with the first inlet opening 11 for leading the fuel to the first fuel passage 8, the second inlet opening 12 for leading the fuel to the second fuel passage 9, and a third inlet opening 45 for leading the fuel to the third fuel passage 43. As shown in this figure, four of the first inlet openings S are formed so as to align concyclically at regular intervals. Four of the second inlet openings 9 and four of the third inlet openings 43 are also formed so as to align concyclically at regular intervals respectively. The first inlet opening 11, the second inlet opening 12, and the third inlet opening 45 are arranged so as not to align in the radial direction with each other.

Next, flow of the fuel in the swirl portion 5 will be described with reference to FIG. 15, FIG. 17, and FIG. 18. In the fuel injection valve 1 of the present embodiment, as one example shown in FIG. 15, when the needle 4 separates from the valve seat 2b, the fuel flows into each of the fuel passages 8, 9, 43 via each of the inlet openings 11, 12, 45. Thereby, as shown in FIG. 17, the counterclockwise first swirl flow F1 is generated in the first fuel passage 8. The clockwise second swirl flow F2 is generated in the second fuel passage 9. The counterclockwise third swirl flow F3 is generated in the third fuel passage 43. As shown in FIG. 18, the first swirl flow F1 and the second swirl flow F2 become opposed flows passing each other across the nozzle hole 3 of the first group of nozzle holes from each other at a downstream end of the swirl portion 5. And, the second swirl flow F2 and the third swirl flow F3 become opposed flows passing each other across the nozzle hole 3 of the second group of nozzle holes from each other at a downstream end of the swirl portion 5. In this case, to the fuel flowing into each of the nozzle holes 3 of the first group of nozzle holes, rotational motion of clockwise is imparted from the first swirl flow F1 and the second swirl flow F2. To the fuel flowing into the nozzle holes 3 of the second group of nozzle holes, rotational motion of counterclockwise is imparted from the second swirl flow F2 and the third swirl flow F3. Thereby, it is possible to generate the swirl flow Fout in each nozzle hole 3.

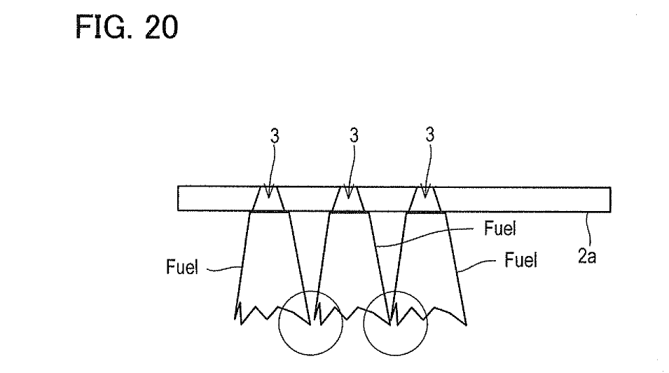

As described above, in the fuel injection valve 1 of the present embodiment, it is possible to generate the swirl Fout in each nozzle hole 3. Thereby, thinning of the fuel Fuel in the nozzle hole 3 can be promoted by the centrifugal force C. Accordingly, fuel atomization can be promoted. In the fuel injection valve 1 of the present embodiment, since eighteen nozzle holes 3 are divided into two so as to be arranged on either of two circumferences, the distance between the nozzle holes 3 can be increased, compared to a case that eighteen nozzle holes 3 are arranged on one circumference. Thereby, as shown in FIG. 20, it is possible to increase the distance that the fuel injected from the nozzle hole 3 proceeds until colliding with the neighbor fuel thereof. FIG. 20 shows a cross section view of the fuel injection valve 1 taken along the line XX-XX in FIG. 19. In this case, as a portion enclosed by solid line in FIG. 20, it is possible to evaporate almost of the fuel before colliding with the neighbor fuel. Thereby, it is possible to suppress increasing a particle size of fuel after injection, even when the number of nozzle holes 3 is increased. Fuel atomization can be promoted while amount of the fuel possible to be injected at once is increased by increasing the number of nozzle holes 3. In the present embodiment, the number of the circumferences where the nozzle holes 3 are arranged to be divided is not limited to two. The nozzle holes 3 may be arranged to be divided into more than three concentric circumferences. In this case, the partition walls and the swirl members are provided in the swirl portion 5 so that the swirl flows which swirls in an opposite direction with each other are generated the inside and the outside of each nozzle hole on each circumference.

### Fifth Embodiment

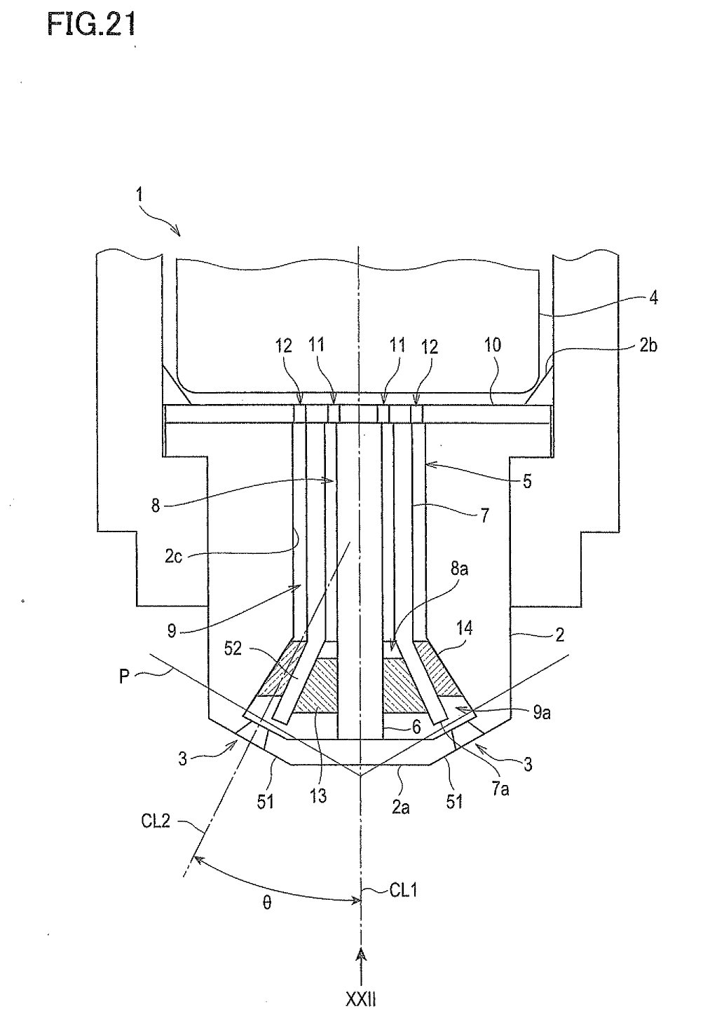

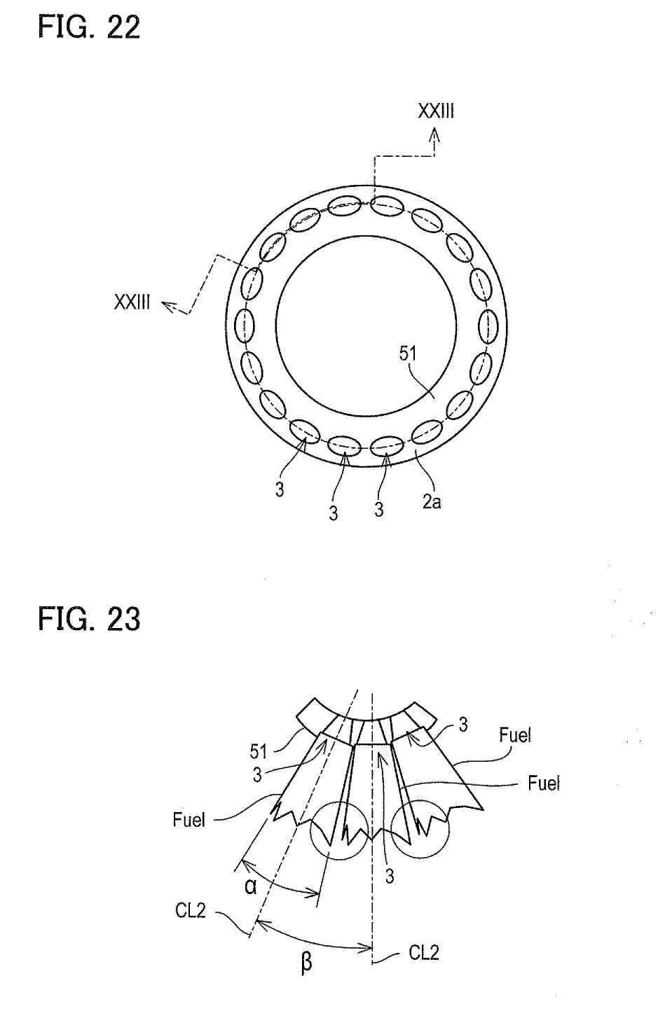

A fuel injection valve according to a fifth embodiment will be described with reference to FIGS. 21 to 23. FIG. 21 is a cross section view showing the swirl portion 5 of the fuel injection valve 1 according to the present embodiment. FIG. 22 is a view showing the fuel injection valve 1 viewed from a direction of an arrow XXII in FIG. 21. In the present embodiment, a structure of the fuel injection valve except a portion shown in FIG. 21 is the same as the first embodiment. In the present embodiment, the same components as those in the first embodiment are denoted by the same reference numeral, and descriptions thereof will be omitted.

As shown in FIG. 21, in the present invention, a shape of the tip portion 2a of the nozzle body 2 differs from that in the first embodiment. As shown in this figure, an outer periphery of the tip portion 2a is provided with an inclined face 51. The inclined face 51 is formed around the entire outer periphery of the tip portion 2a at the same angle. The plurality of nozzle holes 3 is arranged on the inclined face 51. As shown in FIG. 22, the nozzle holes 3 are arranged to be aligned on concyclically at regular intervals. Thereby, each nozzle hole 3 is arranged so that a center line CL2 of the nozzle hole 3 is inclined with respect to the center line CL1 of the fuel injection valve 1 at a predetermined angle θ.

The inner peripheral surface 2c of the nozzle body 2 at the swirl portion 5 is formed so as to spread gradually to the outer periphery side from the middle thereof in order to provide fuel to each nozzle hole 3. The partition wall 7 has a taper portion 52 which is spread gradually to the outer periphery side as with the inner peripheral surface 2c of the nozzle body 2. The taper portion 52 is spread gradually in a direction perpendicular to the inclined face 51. Thereby, in the present embodiment, the first fuel passage 8 and the second fuel passage 9 are formed so as to spread gradually to the outer periphery side from the middle of them respectively. A portion which is spread gradually to the outer periphery side of each fuel passage 8, 9 is referred to as a spread passage 8a, 9a. An angle of the inner peripheral surface 2c of the nozzle body 2 and an angle of the taper portion 52 are set the predetermined angle θ of the nozzle hole 3 as above, for example. As shown in this figure, the first swirl member 13 and the second swirl member 14 are arranged in the spread passages 8a, 9a of the fuel passages 8, 9 respectively. Since the swirl members 13, 14 are arranged in the spread passages 8a, 9a respectively, as the swirl members 13, 14, publicly known spiral bevel gears are used, for example.

According to the fuel injection valve 1 of the present embodiment, since the spread passages 8a, 9a are formed in the fuel passages 8, 9 respectively, the first swirl flow F1 can be led to the inside of the nozzle holes 3 and the second swirl flow F2 can be led to the outside of the nozzle holes 3. The first swirl flow F1 and the second swirl flow F2 can be opposed to each other on a virtual plane P (see FIG. 21) which is perpendicular to the center line CL2 of nozzle hole 3. Thereby, even if the nozzle holes 3 are inclined, it is possible to generate the swirl flow Fout in the nozzle holes 3. Accordingly, thinning of the fuel can be promoted. FIG. 23 shows a cross section view of the fuel injection valve 1 taken along the line XXIII-XXIII in FIG. 22. As shown in this figure, in the fifth embodiment, since the center line CL2 of each nozzle hole 3 is inclined, the collision of injected fuels can be successively suppressed by making an angle β between the center lines CL2 of neighboring nozzle holes 3 larger than a spread angle α of fuel which is injected from each nozzle hole 3. Even if the angle β is smaller than the angle α, it is possible to increase a distance that the fuel injected from the nozzle hole 3 proceeds until colliding with the neighbor fuel. In this case, as a portion enclosed by solid line in FIG. 23, it is possible to evaporate almost of the fuel before the collision with the neighbor fuel. Thereby, fuel atomization can be promoted while the amount of the fuel possible to be injected at once is made to increase by increasing the number of nozzle holes 3 which are provided on tip portion 2a.

### Sixth Embodiment

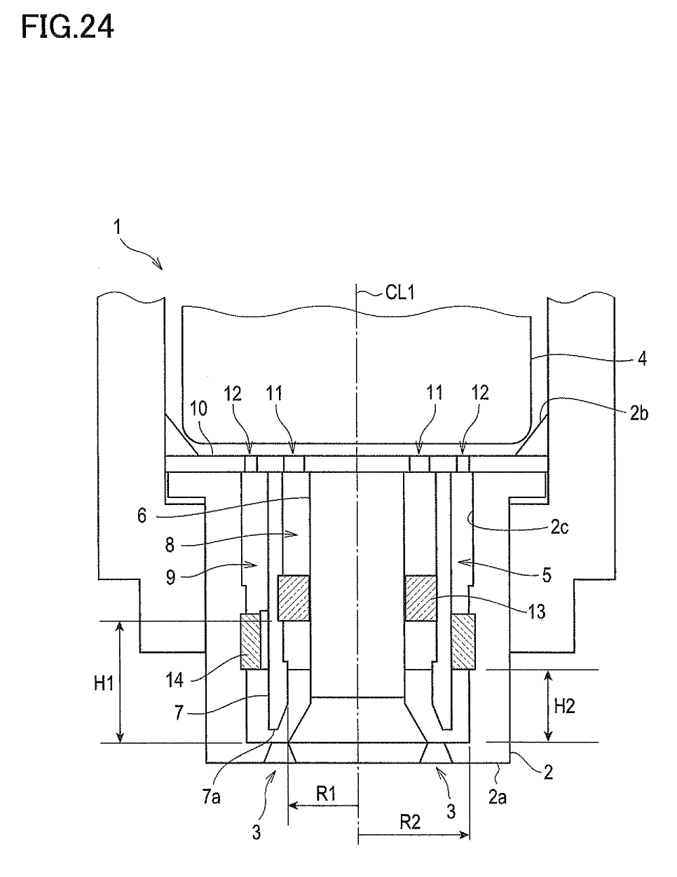

A fuel injection valve according to a sixth embodiment will be described with reference to FIG. 24. FIG. 24 is a cross section view showing the swirl portion 5 of the fuel injection valve 1 according to the present embodiment. In the present embodiment, the same components as those in the first embodiment are denoted by the same reference numeral, and descriptions thereof will be omitted. Friction is generated between the fuel which flows in each fuel passage 8, 9 and the inner peripheral surface 2c of the nozzle body 2. Thereby, each swirl flow F1, F2 is affected by the friction. A position of the first swirl member 13 and a position of the second swirl member 14 are adjusted so that friction loss of the swirl flows F1, F2 are same as each other.

It is considered that the friction loss of the swirl flow is proportional to a distance (swirl distance) where the swirl flow swirled. A swirl distance L1 of the first swirl flow F1 is expressed in the following equation (1) by using a swirling radius R1 shown in FIG. 24 and the number of times (number of swirling times) N1 that the fuel swirled after passing through the first swirl member 13 until arriving at the nozzle hole 3.

L1=2πR1N1 (1)

Similarly, A swirl distance L2 of the second swirl flow F2 is expressed in the following equation (2) by using a swirling radius R2 shown in FIG. 24 and the number of times (number of swirling times) N2 that the fuel swirled after passing through the second swirl member 14 until arriving at the nozzle hole 3.

L2=2πR2N2 (2)

In order to make the friction loss of the first swirl flow F1 and the friction loss of the second swirl flow F2 equal to each other, it is necessary that the swirl distance L1 and the swirl distance L2 are made equal to each other. It is considered that the first number of swirling times N1 is proportional to a value V1/H1 which is a value obtained by dividing a fuel flow velocity V1 in the direction of the center line CL1 by a swirl section length H1 shown in FIG. 24. Similarly, it is considered that the second number of swirling times N2 is proportional to a value V2/H2 which is a value obtained by dividing a fuel flow velocity V2 in the direction of the center line CL1 by a swirl section length H2 shown in FIG. 24. Therefore, in order to make the swirl distance L1 of the first swirl flow F1 and the swirl distance L2 of the second swirl flow F2 equal to each other, it is necessary that the following equation (3) is satisfied.

2πR1V1/H1=2πR2V2/H2 3)

Here, assuming V1=V2, if the following equation (4) is satisfied, the swirl distance L1 of the first swirl flow F1 and the swirl distance L2 of the second swirl flow F2 are made equal to each other.

R1/H1=R2/H2 (4)

The equation (4) can be modified as the following equation (5

R1×H2=R2×H1 (5)

By arranging the first swirl member 13 and the second swirl member 14 so that the equation (5) is satisfied, it is possible to make the friction loss of the first swirl flow F1 and the friction loss of the second swirl flow F2 almost equal to each other. By using the equation (5), the length of each fuel passage 8, 9 can be decreased without generating a big gap between flow intensity of the first swirl flow F1 and flow intensity of the second swirl flow F2. For example, when the swirl section length H1 of the first swirl flow is decreased by a length ΔH1, a length ΔH2 to be reduced from the swirl section length H2 of the second swirl flow can be calculated according to the following equation (6).

ΔH2=H2−(H1−ΔH1)R2/R1 (6)

As described above, according to the fuel injection valve 1 of the sixth embodiment, since the first swirl member 13 and the second swirl member 14 are arranged so that the above equation (5) is satisfied, it is possible to make the friction loss of the first swirl flow F1 and the friction loss of the second swirl flow F2 almost equal to each other. Thereby, the fuel flowing into the nozzle hole 3 can be made to swirl without a tendency toward the center side or outer periphery side. Accordingly, it is possible to generate the strong swirl flow rout in the nozzle hole 3, and thinning of the fuel can be promoted. By adjusting the length of each fuel passage 8, 9 by using the above equation (6), it is possible to decrease the length of each fuel passage 8, 9 while balancing the friction loss of the fuel passages with each other.

### Seventh Embodiment

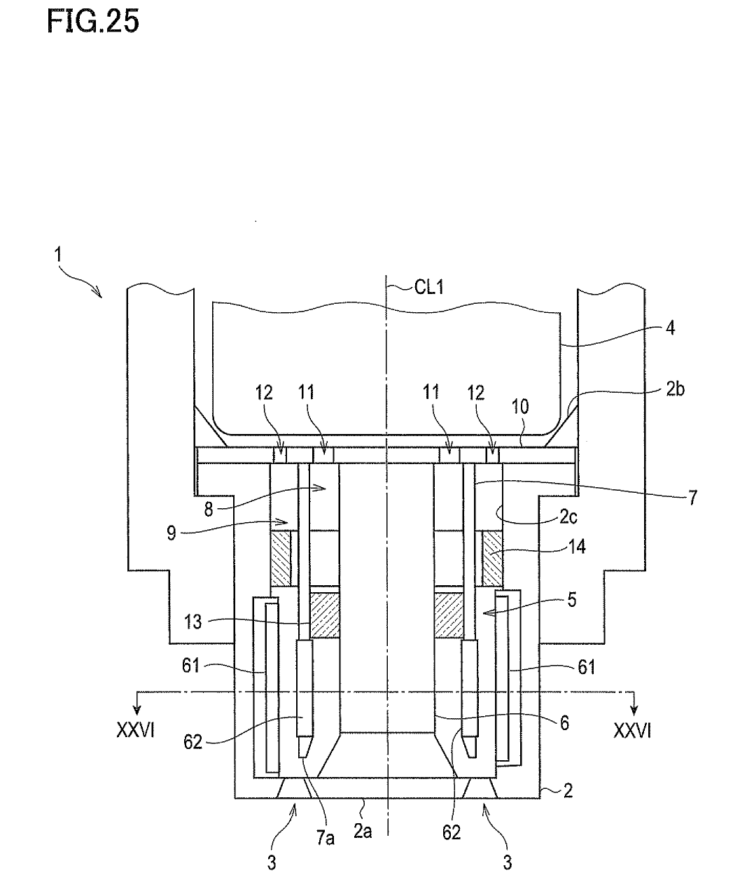

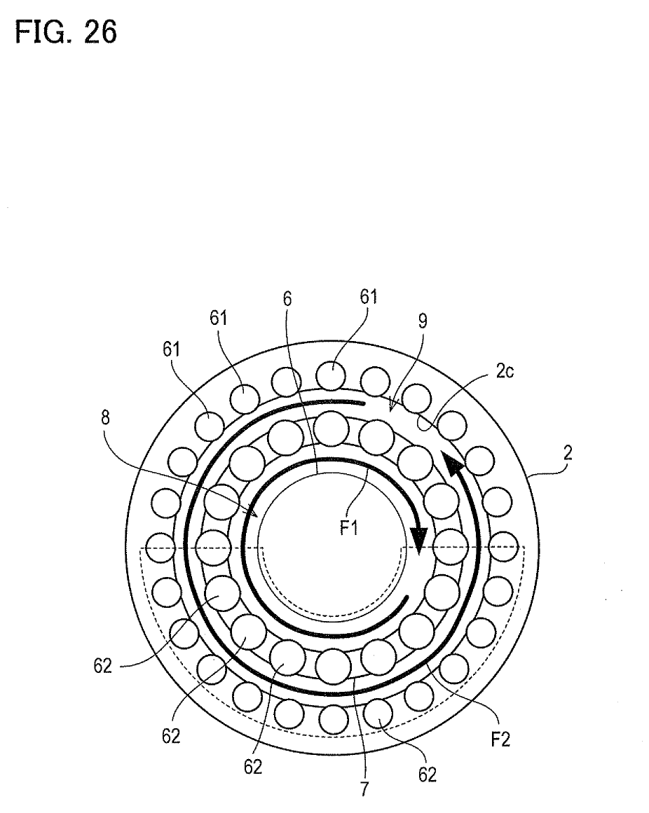

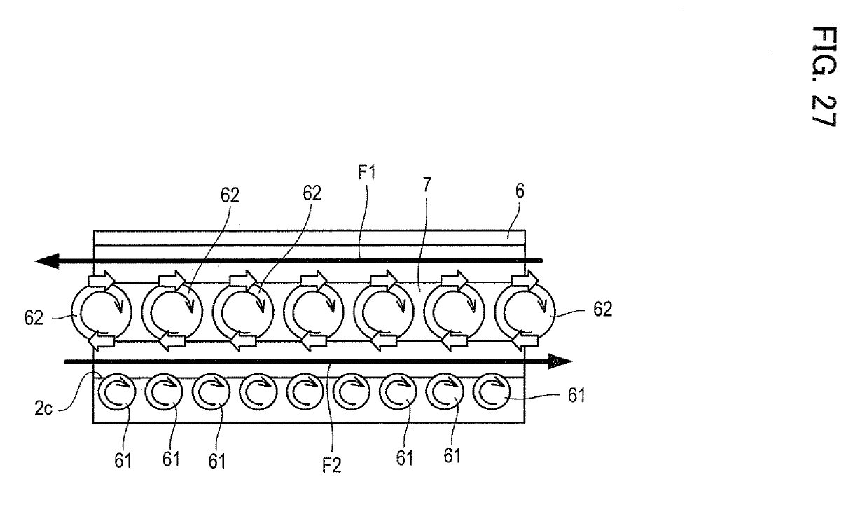

A fuel injection valve according to a seventh embodiment will be described with reference to FIGS. 25 to 27. FIG. 25 is a cross section view showing the swirl portion 5 of the fuel injection valve 1 according to the present embodiment. FIG. 26 is a cross section view of the fuel injection valve 1 taken along the line XXVI-XXVI in FIG. 25. FIG. 27 is a development view showing a portion enclosed by broken line in FIG. 26. In the present embodiment, the same components as those in the first embodiment are denoted by the same reference numeral, and descriptions thereof will be omitted. As shown in FIGS. 25 and 26, the fuel injection valve 1 of the present embodiment differs from the first embodiment in that the inner peripheral surface 2c of the nozzle body 2 and the partition wall 7 are provided with rollers 61, 62 respectively. Other components are same as those in the first embodiment.

The inner peripheral surface 2c of the nozzle body 2 is provided with the plurality of rollers 61. Each roller 61 is cylindrical shaped. Each roller 61 is supported by the nozzle body 2 so as to be rotatable about a center axis thereof. As shown in FIG. 26, the rollers 61 are arranged along the whole circumference at regular intervals. Each roller 61 is arranged to the nozzle body 2 so that a portion of roller 61 is exposed to the second fuel passage 9. The partition wall 7 is also provided with the plurality of rollers 62. Each roller 62 is also cylindrical shaped, and is supported by the partition wall 7 so as to be rotatable about a center axis thereof. The rollers 62 are also arranged along the whole circumference at regular intervals. Each roller 62 is arranged so that a portion of roller 62 is exposed to the first fuel passage 8 and the second fuel passage 9. The rollers 61 and the rollers 62 can be provided easily by using an already known roller-bearing. For example, the rollers 61 can be provided by installing a roller bearing without an inner race in the nozzle body 2. The rollers 62 can be provided by installing in the partition wall 7, a roller bearing having only rollers supported by a cage without the inner and outer races.

When the first swirl flow F1 is generated in the first fuel passage 8, the first swirl flow F1 rotates the rollers 62 while swirling in the first fuel passage 8, as shown in FIG. 27. As well known, friction force of rolling friction at the moment when the rollers 62 are rotated by the fuel is smaller than friction force of sliding friction to be generated between a plane and the fuel. Thereby, by arranging the rollers 62 in this manner, the friction loss of the first swirl flow F1 can be decreased. Similarly, the second swirl flow F2 rotates the rollers 61 and the rollers 62 during swirling. Thereby, the friction loss of the second swirl flow F2 also can be decreased.

According to the fuel injection valve 1 of the seventh embodiment, since the friction loss of each swirl flow F1, F2 can be decreased, decrease of the flow velocity of each swirl flow F1, F2 can be suppressed. Thereby, each swirl flow F1, F2 can be made stronger. Accordingly, thinning of the fuel can be promoted by making the swirl flow Fout stronger in the nozzle hole 3.

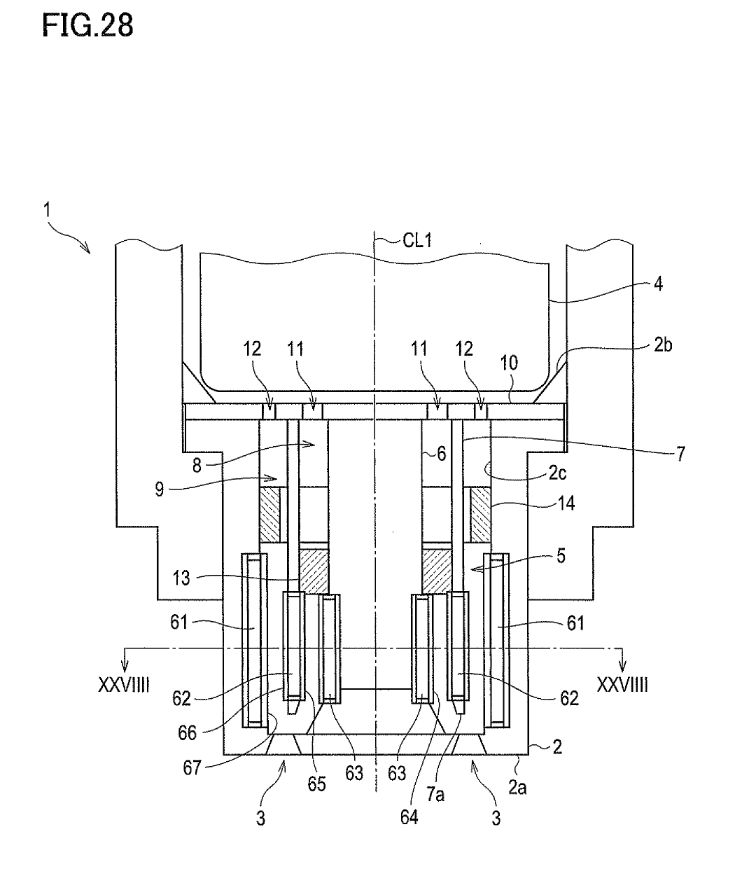

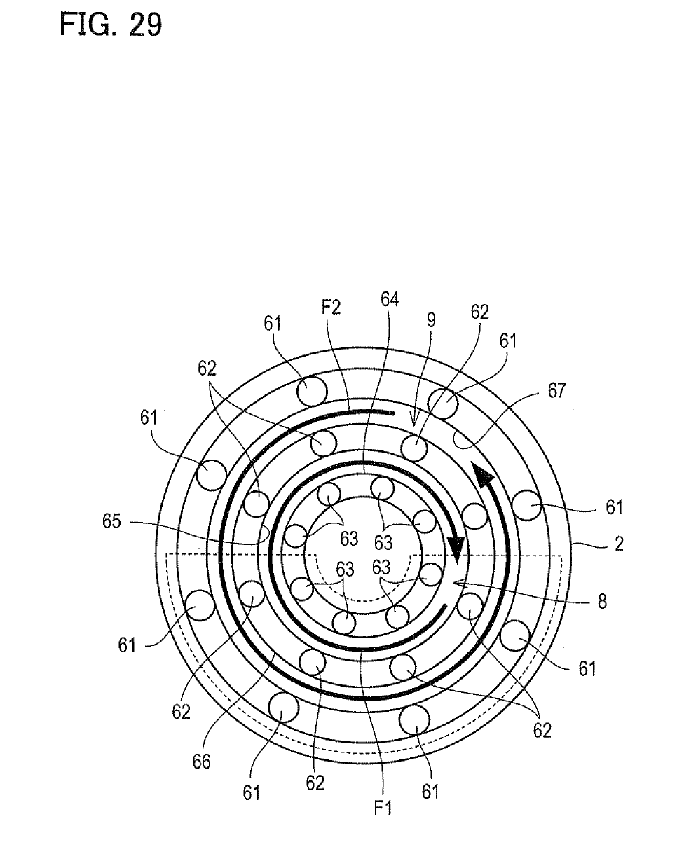

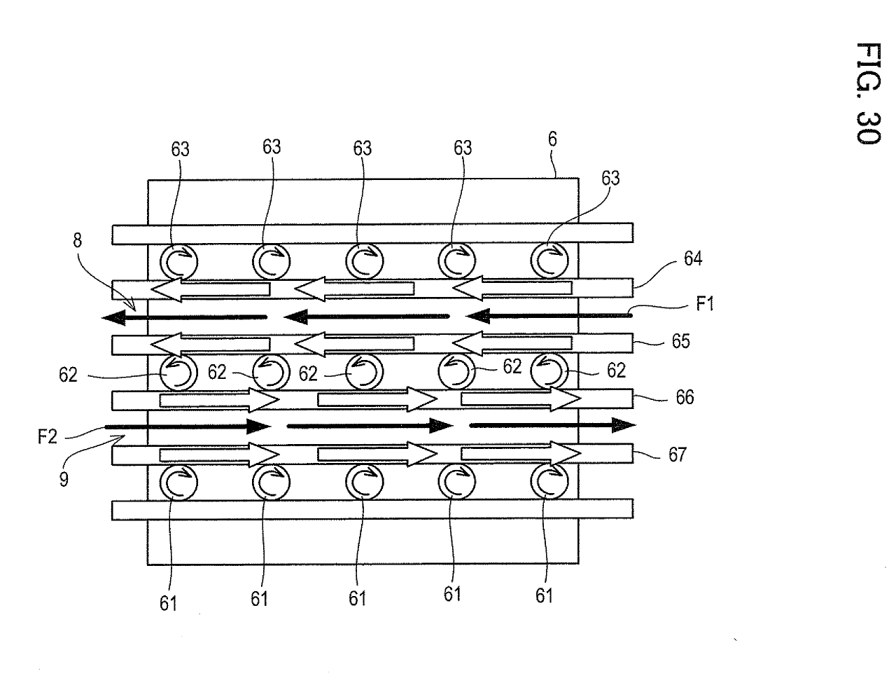

A variation of the fuel injection valve according to the seventh embodiment will be described with reference to FIGS. 28 to 30. FIG. 28 is a cross section view showing the swirl portion 5 of the present variation. FIG. 29 is a cross section view of the fuel injection valve 1 taken along the line XVIIII-XVIIII in FIG. 28. FIG. 30 is a development view showing a portion enclosed by broken line in FIG. 29. As shown in FIGS. 28 and 29, in the present variation, a plurality of rollers 63 are arranged in the center column 6. The rollers 63 are supported by the center column 6 so as to be rotatable about a center axis thereof. The rollers 63 are arranged along the whole circumference at regular intervals. A cylindrical first outer wall 64 is provided on the outer periphery side of the rollers 63 so as to rotate on the rollers 63. The partition wall 7 is provided with a cylindrical first inner wall 65 and a second outer wall 66. The first inner wall 65 is provided on the inside of the rollers 62 so as to rotate on the rollers 62. The second outer wall 66 is provided on the outside of the rollers 62 so as to rotate on the rollers 62. The inner peripheral surface 2c of the nozzle body 2 is provided with a cylindrical second inner wall 67. The second inner wall 67 is provided on the inside of the rollers 61 so as to rotate on the rollers 61. The rollers 61-63, the inner walls 65, 67, and the outer walls 64, 66 may be provided by already known roller bearings. In this case, an outer race of the roller bearing is used as the outer wall 64, 66. And, an inner race of the roller bearing is used as the inner wall 65, 67.

In the present variation, when the first swirl flow F1 is generated in the first fuel passage 8, the first swirl flow F1 rotates the first outer wall 64 and the first inner wall 65 by friction force, as shown in FIG. 30. As described above, the first outer wall 64 rotates on the rollers 63. The first inner wall 65 rotates on the rollers 62. Therefore, friction force of sliding friction to be generated between the first swirl flow F1 and each of the first outer wall 64 and the first inner wall 65 becomes smaller than friction force of sliding friction to be generated between fixed walls and the fuel. The first outer wall 64 and the first inner wall 65 also rotate by inertial force. Thereby, the friction loss of the first swirl flow F1 can be decreased. Similarly, since the second swirl flow F2 rotates the second outer wall 66 and the second inner wall 67, the friction loss of the second swirl flow F2 also can be decreased.

According to the fuel injection valve 1 of the present variation, the inner peripheral surface 2c of the nozzle body 2 and a surface of the partition wall 7 can be made smooth. In a case that viscosity of the fuel is high, if the fixed wall exists in the fuel passage 8, 9 except the rollers, the friction loss of sliding friction between the fixed wall and the fuel increases. In the present variation, the inner wall is provided on the inside of the rollers, and the outer wall is provided on the outside of the rollers. Thereby, the friction loss of each swirl flow F1, F2 can be decreased even if viscosity of the fuel is high. It is possible to generate the strong swirl flow Fout in the nozzle hole 3 by making each swirl flow F1, F2 strong. Accordingly, thinning of the fuel can be promoted.

In the present embodiment, method of reducing the friction loss is not limited to the rollers. For example, the friction loss may be decreased by providing a plurality of micro-asperities, i.e. dimples on each of the inner peripheral surface 2c of the nozzle body 2 and a surface of the partition wall 7.

### Eighth Embodiment

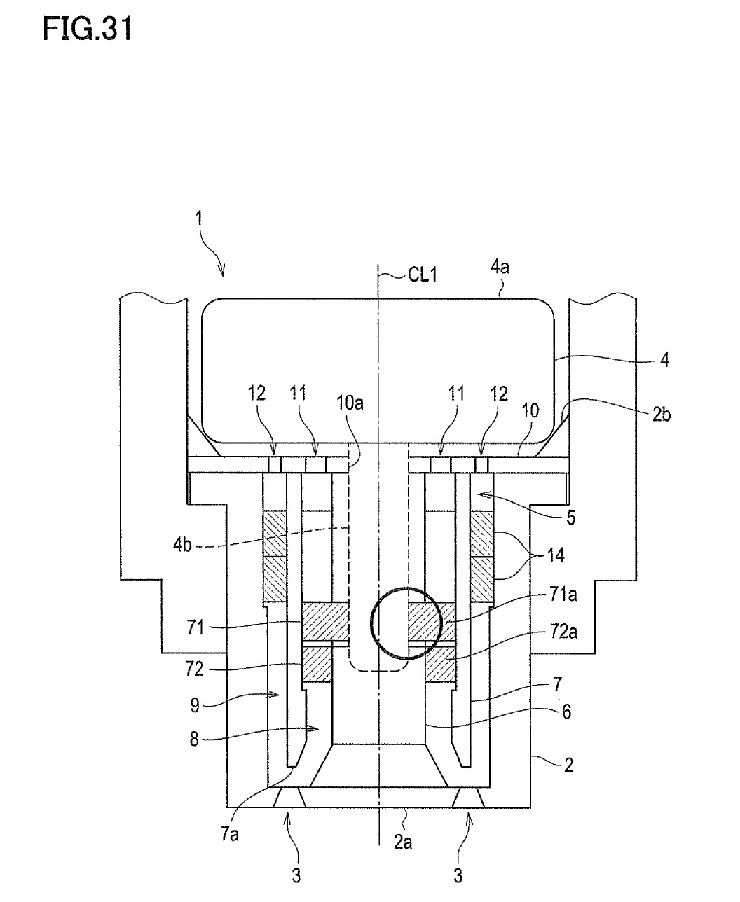

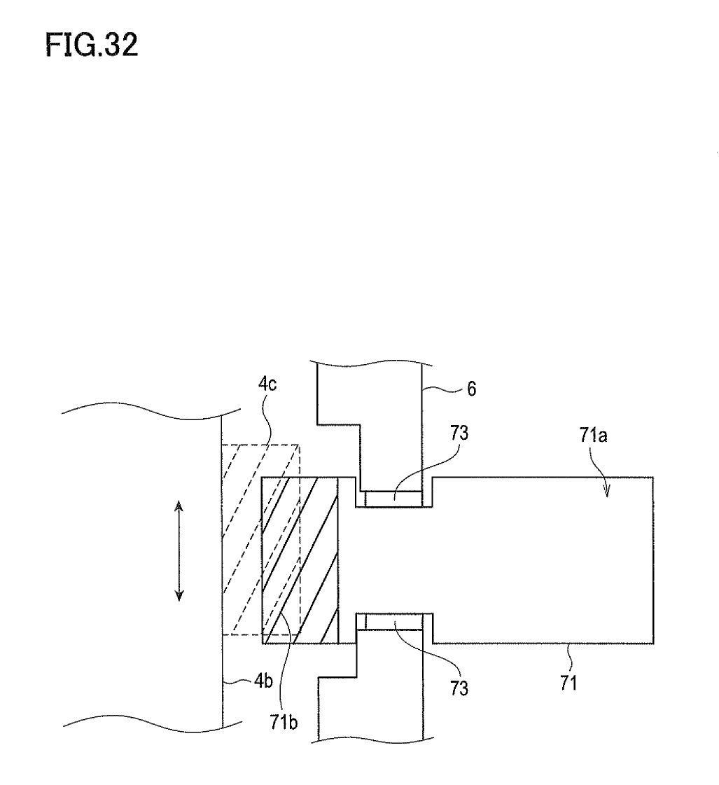

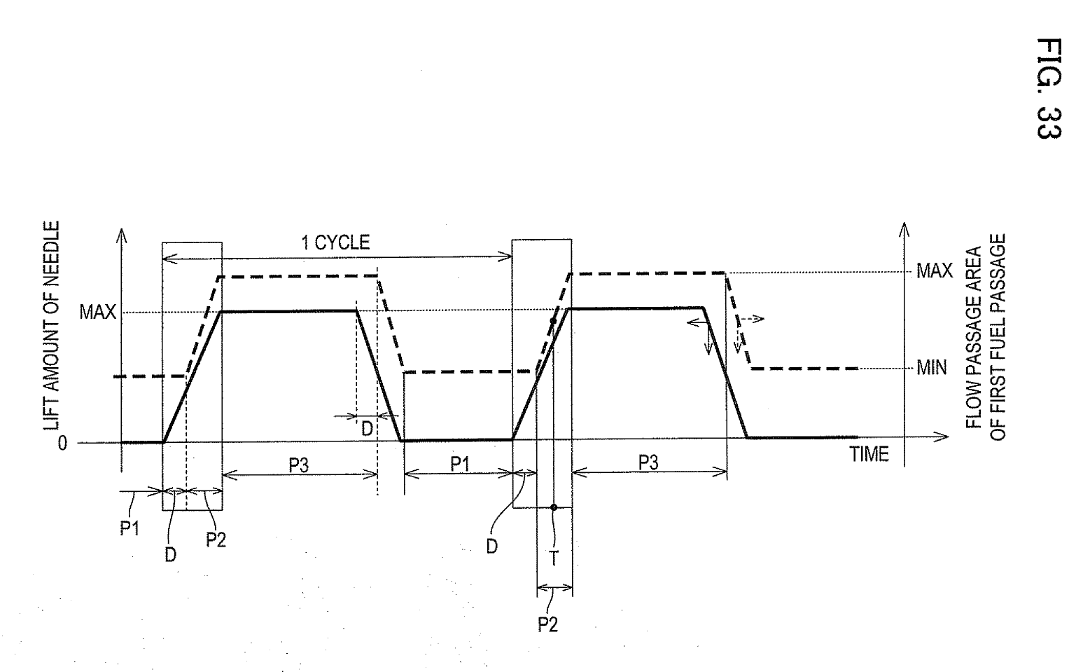

A fuel injection valve according to an eighth embodiment will be described with reference to FIGS. 31 to 36. FIG. 31 is a view showing the swirl portion 5 of the fuel injection valve of the present embodiment. FIG. 32 is an enlarged view showing a portion enclosed by solid line in FIG. 31. In the present embodiment, the same components as those in the first embodiment are denoted by the same reference numeral, and descriptions thereof will be omitted. As shown in FIG. 31, in the present embodiment, a first helical gear 71 serving as a flow passage area changing device is arranged in the first fuel passage 8. The first fuel passage 8 is provided with a second helical gear 72 serving as the first swirl member. The first helical gear 71 has plural external teeth 71a which is arranged on an outer peripheral surface and plural internal teeth 71b (see FIG. 32) which is arranged on an inner peripheral surface. The internal teeth 71b are also inclined with respect to the center line CL1 as with the external teeth 71a. The second helical gear 72 has plural external teeth 72a which is arranged on an outer peripheral surface. The external teeth 72a of the second helical gear 72 are formed so that the number and shape thereof are the same as the number and shape of the external teeth 71a of the first helical gear 71. The second helical gear 72 is fixed between the center column 6 and the partition wall 7 so as to be incapable of rotating. As shown in FIG. 32, the first helical gear 71 is supported by the center column 6 via thrust bearings 73, 73 so as to be rotatable around the center line CL1.

As shown in FIG. 31, the center column 6 is a hollow. The needle 4 has a valving element portion 4a and a cylindrical shaft portion 4b. The shaft portion 4b is provided on the valving element portion 4a coaxially. The distribution plate 10 is provided with an insert hole 10a where the shaft portion 4b is inserted so as to be capable of moving in the direction of center line CL1. The needle 4 is arranged so that the shaft portion 4b is inserted in the center column 6 through the insert hole 10a. As shown in FIG. 32, the shaft portion 4b is provided with plural external teeth 4c which engage with the internal teeth 71b of the first helical gear 71. In this manner, by engaging the external teeth 4c arranged on the shaft portion 4b with the internal teeth 71b of the first helical gear 71, it is possible to rotate the first helical gear 71 by converting the linear motion of the needle 4 into the rotation motion around the center line CL1 by means of the external teeth 4c and the internal teeth 71b. Therefore, the external teeth 4c and the internal teeth 71b correspond to a motion conversion mechanism of the present invention. In this case, it is possible to interlock the needle 4 and the first helical gear 71.

When the needle 4 is opened, the needle 4 is lifted from a fully closed position where the valving element portion 4a contacts with the valve seat 2b to a predetermined fully opened position. The first helical gear 71 is arranged so that each of the external teeth 71a covers over the space between the external teeth 72a of the second helical gear 72 when the needle 4 is at the fully closed position i.e. the lift amount of needle 4 is 0. In this case, viewing in the direction of center line CL1, since each of the external teeth 71a of the first helical gear 71 is arranged between the external teeth 72a of the second helical gear 72, the flow passage area of the fuel for the first swirl member 13 becomes minimum. The external teeth 4c of the shaft portion 4b and the internal teeth 71b of the first helical gear 71 are arranged so that the external teeth 71a of the first helical gear 71 and the external teeth 72a of the second helical gear 72 are overlapped with each other viewing in the direction of the center line CL1 when the needle 4 is lifted to the fully opened position. In this case, the flow passage area of the fuel for the first swirl member 13 becomes maximum. As mentioned above, in the fuel injection valve 1 of the present embodiment, the passage area of the first swirl member becomes minimum when the needle 4 is at the fully closed position, and the passage area of the first swirl member becomes maximum when the needle 4 moves to the fully opened position.

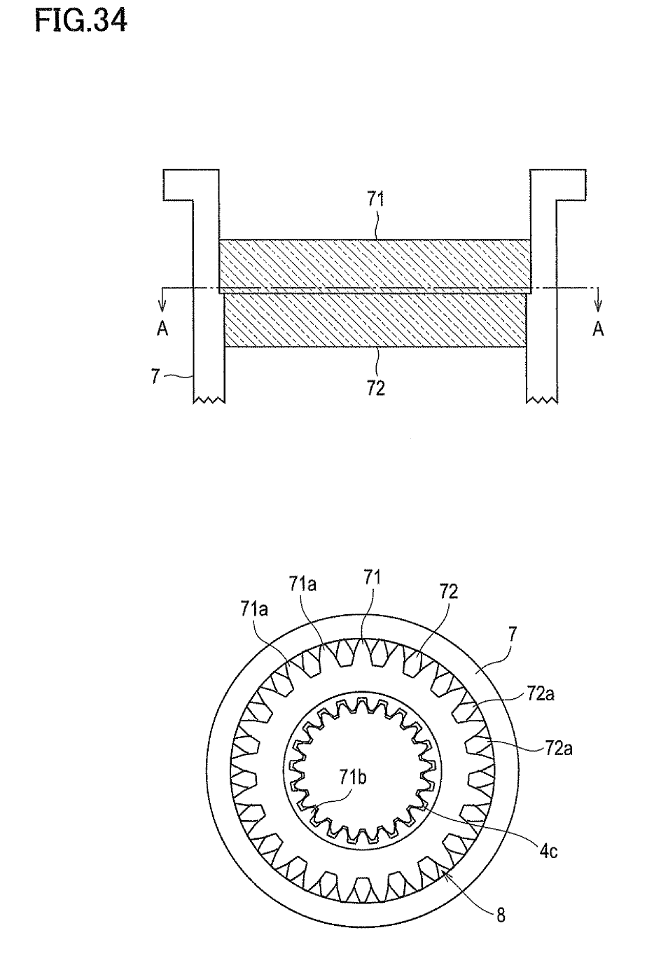

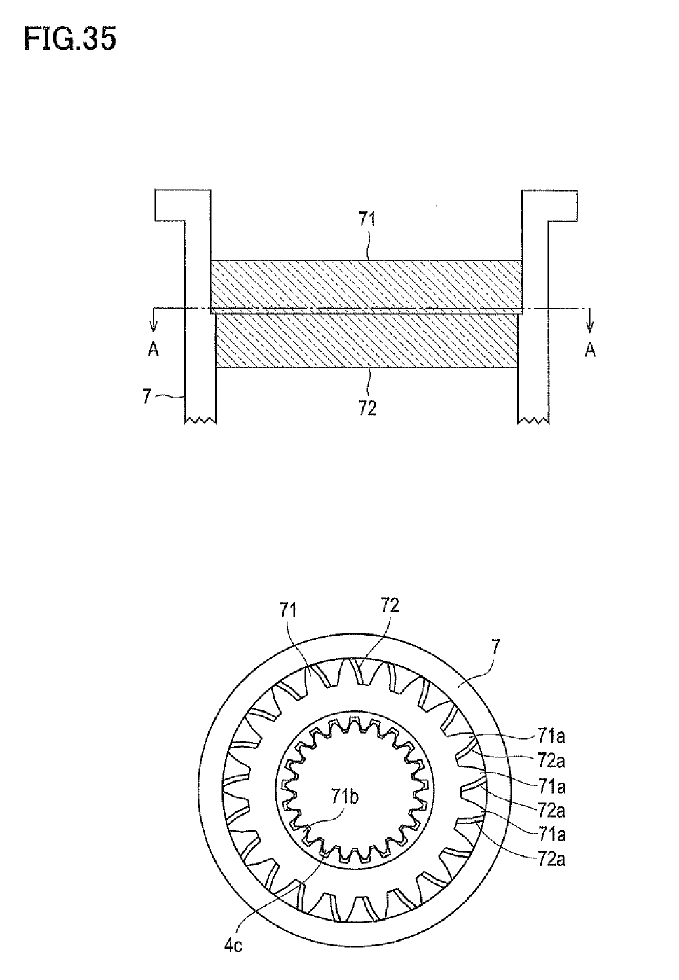

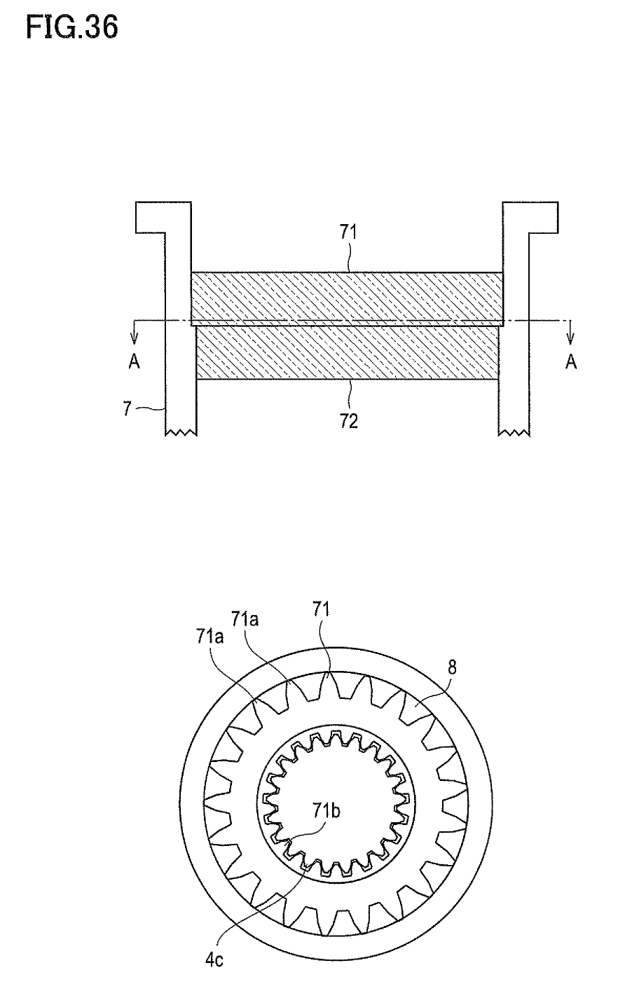

Next, actions each of the needle 4 and the first helical gear 71 will be described with reference to FIGS. 33 to 36. FIG. 33 is a graph showing temporal variations of the lift amount of the needle 4 and the flow passage area of the first fuel passage 8 at a position where the first helical gear 71 is located. In FIG. 33, a solid line shows the temporal variation of the lift amount of the needle 4, and a broken line shows the temporal variation of the flow passage area of the first fuel passage 8. FIG. 34 shows a state of the first helical gear 71 and the second helical gear 72 when the needle 4 is at the fully closed position. FIG. 35 shows a state of the first helical gear 71 and the second helical gear 72 when the needle 4 is lifted. FIG. 36 shows a state of the first helical gear 71 and the second helical gear 72 when the needle 4 is at the fully opened position. A lower figure in FIGS. 34 to 36 shows a cross section view of the first fuel passage 8 taken along the line A-A in the upper figure of each of the figures. In FIGS. 34 to 36, illustration of the center column 6 is omitted.

In FIG. 33, the first helical gear 71 and the second helical gear 72 become a state shown in FIG. 34 in a period P1 that the lift amount of the needle 4 is 0, i.e., the needle 4 is at the fully closed position. Thereby, the flow passage area of the first fuel passage 8 becomes minimum. When the needle 4 is lifted from this state, the flow passage area of the first fuel passage 8 increases gradually as the needle 4 is lifted, as shown in a period P2 of FIG. 33. FIG. 35 shows a state of the first helical gear 71 and the second helical gear 72 at a moment T in the period P2. A backlash is provided between the external teeth 4c of the shaft portion 4b and the internal teeth 71a of the first helical gear 71. Thereby, a dead zone D is generated in a time from the moment when the needle 4 begins to lift to the moment when the flow passage area of the first fuel passage 8 begins to change. The flow passage area of the first fuel passage 8 reaches maximum as shown in FIG. 36, when the lift amount of the needle 4 reaches maximum, i.e., the needle 4 reaches the fully opened position. This state is kept until the needle 4 begins to move toward the valve seat 2b side and the first helical gear 71 begins to rotate. Namely, this state is kept during a period P3 of FIG. 33. When the needle 4 moves from the fully opened position toward the valve seat 2b side, the first helical gear 71 rotates in an opposite direction to a rotation direction of the case that the needle 4 is lifted. Thereby, the flow passage area of the first fuel passage 8 is decreased as the needle 4 moves toward the valve seat 2b side. When the lift amount of the needle 4 reaches 0, the state of the first helical gear 71 and second helical gear 72 return to the state shown in FIG. 34. After this, these actions are repeated.

As described above, according to the fuel injection valve of the eighth embodiment, the flow passage area of the first fuel passage 8 can increase as the lift amount of the needle 4 increases. The amount of fuel which flows into the swirl portion 5 is small, immediately after the needle 4 begins to be lifted. In this period, the flow passage area of the first fuel passage 8 is small. Therefore, it is possible to increase the flow velocity of the first swirl flow F1, even if the amount of fuel is small. Accordingly, the strong first swirl flow F1 can be generated. On the other hand, when the needle 4 moves and reaches the fully opened position, the amount of fuel which flows into the swirl portion 5 becomes large. In this case, since the flow passage area of the first fuel passage 8 is maximum, the pressure loss can be decreased. Thereby, the strong first swirl flow F1 can be generated, also in this case. According to the fuel injection valve of the eighth embodiment, the strong first swirl flow F1 can be generated during a period until the needle 4 reaches the fully opened position immediately after the needle 4 began to be lifted. Therefore, it is possible to make the swirl flow Fout strong in the nozzle hole 3. Accordingly, it is possible to promote the thinning of the fuel, and promote the fuel atomization.

In the present embodiment, the second fuel passage 9 may be provided with the first helical gear serving as a flow passage area changing device so that the flow passage area can be changed. This first helical gear is provided so that the flow passage area of the second fuel passage 9 increases gradually as the needle 4 is lifted, as with the first helical gear of the first fuel passage 8 above mentioned. A driving device for rotating the first helical gear is not limited to the valving element. The first helical gear may be rotated by utilizing an appropriate driving device such as a motor or the like.

The present invention is not limited to the above-described embodiments, and may be executed in various modes. For example, the fuel injection valve of the present invention may be applied to a cylinder direct injection type internal combustion engine, in which fuel is injected directly into cylinders. If two swirl flows can be generated in the nozzle body, the partition wall may be omitted. Each swirl member is enough as long as the swirl flows which exist next to each other are swirled in the opposite direction to each other. In the above described embodiments, a swirl flow of one side of the nozzle hole and a swirl flow of the other side of the nozzle hole are generated so that their centers exist at the same position. However, the centers of these swirl flows may be on different positions from each other. For example, the center of the first swirl flow may be set on one side of the nozzle hole, and the center of the second swirl flow may be set on the other side of the nozzle hole. In this case, the first swirl flow and second swirl flow are swirled in the same direction so that they flow in an opposite direction to each other when they pass each other across the nozzle hole from each other.

The above described embodiments may be combined appropriately with each other, as long as they do not bother each other. For example, the swirl member may be configured by a plurality of helical gears, the cutout portion may be formed in the nozzle hole, and the inner peripheral surface of the nozzle body and partition wall may be provided with the rollers. By combining the above described embodiments appropriately in this manner, thinning of the fuel can be promote further.

1. A fuel injection valve comprising a nozzle body having at least one nozzle hole in a tip portion thereof, where fuel led into the nozzle body is injected from the nozzle hole, wherein the fuel injection valve comprises:
a first fuel swirling device for swirling a part of the fuel in the nozzle body to generate a first swirl flow; and a second fuel swirling device for swirling at least a part of remaining fuel left in the nozzle body to generate a second swirl flow, wherein
the first fuel swirling device and the second fuel swirling device are mounted in the nozzle body so that, as viewed in a direction of a center line of the nozzle hole, the first swirl flow is located on one side of an inlet opening of the nozzle hole, while the second swirl flow being located on the other side of the inlet opening of the nozzle hole, and the first swirl flow and the second swirl flow are formed as opposed flows passing each other across the nozzle hole from each other.

2. The fuel injection valve according to claim 1, wherein the tip portion is provided with a plurality of nozzle holes in such a way that the plurality of nozzle holes are aligned concyclically,
the first fuel swirling device is provided so that the first swirl flow is generated on a location closer to a center side than a location of the plurality of nozzle holes while swirling in a predetermined swirling direction, and
the second fuel swirling device is provided so that the second swirl flow travels in a same direction as the first swirl flow, while swirling in a direction opposite to the predetermined swirling direction, and is generated on a location closer to an outer periphery side than a location of the plurality of nozzle holes.

3. The fuel injection valve according to claim 1, further comprising,
a partition wall which separates an inside of the nozzle body into a first fuel passage and a second fuel passage so as to be merged at the inlet opening of the nozzle hole, wherein
the first fuel swirling device is arranged in the first fuel passage, and the second fuel swirling device is arranged in the second fuel passage.

4. The fuel injection valve according to claim 1, wherein
the tip portion is provided with a plurality of nozzle holes, a part of the nozzle holes are arranged on a first circumference to form a first group of nozzle holes, while remains of the nozzle holes are arranged on a second circumference coaxially with the first circumference and form a second group of nozzle holes at an outside of the first group of nozzle holes,
the first fuel swirling device is arranged so as to generate the first swirl flow on a center side of the first group of the nozzle holes by swirling first fuel as a part of the fuel led into the nozzle body in a predetermined swirling direction, and
the second fuel swirling device is arranged so as to generate the second swirl flow traveling in a same direction as the first swirl flow on an outer periphery side than the first group of nozzle holes and on a location closer to the center side than the second group of nozzle holes by swirling in a direction opposite to the predetermined swirling direction, second fuel as a part of remaining fuel in the nozzle body, wherein the fuel injection valve further comprises:
a third fuel swirling device for swirling in the predetermined swirling direction, remaining fuel of the fuel led into the nozzle body except the first fuel and the second fuel to generate on an outside of the second swirl flow, a third swirl flow traveling in the same direction as the first swirl flow;
a first partition wall for separating the inside of the nozzle body into a first fuel passage where the first swirl flow is generated and remaining space; and
a second partition wall for separating the remaining space in the nozzle body into a second fuel passage where the second swirl flow is generated and a third fuel passage where the third swirl flow is generated.

5. The fuel injection valve according to claim 3, further comprising,
a valving element for leading the fuel into the nozzle body by lifting the valving element from a state that the valve element is contacted to a valve seat formed on the nozzle body, the valving element being provided on an upstream side of the nozzle body, and
a flow passage area changing device for changing flow passage area of at least either one of the first fuel passage and the second fuel passage depending on lift amount of the valving element.

6. The fuel injection valve according to claim 5, wherein,
the flow passage area changing device increases the flow passage area of at least one of the first fuel passage and the second fuel passage with increase in the lift amount of the valving element.

7. The fuel injection valve according to claim 5, wherein
the first fuel passage is formed cylindrically, and
to the first fuel passage, a first helical gear is provided as the flow passage area changing device, the first helical gear being provided coaxially with the first fuel passage and rotatably around an axis of the first fuel passage, and a second helical gear is provided as the first fuel swirling device, the second helical gear being provided coaxially and overlappedly with the first helical gear to be fixed in the first fuel passage, the second helical gear having a same shape of the first helical gear, wherein the fuel injection valve further comprises
a motion conversion mechanism which converts a linear motion of the valving element to a rotation motion of the first helical gear.

8. The fuel injection valve according to claim 3, wherein
each of the fuel passages is formed cylindrically, and
each of the fuel swirling devices is arranged in the nozzle body so that values are equaled with each other, each of the values being obtained by dividing a radius of the fuel passage where the generated swirl flow flows by a distance from the fuel swirling device which generates the swirl flow to the nozzle hole.

9. The fuel injection valve according to claim 3, comprising
a friction reducing device which is provided on at least either one of an inner peripheral surface of the nozzle body and a surface of the partition wall arranged in the nozzle body, for reducing friction between those surfaces and the fuel.

10. The fuel injection valve according to claim 9, wherein
the friction reducing device is a plurality of rollers which are arranged so as to be capable of rotating in a direction where the fuel swirls.

11. The fuel injection valve according to claim 3, wherein,
the partition wall in the nozzle body has a taper portion which is spread to the outer periphery side, and is provided on an end portion of a downstream side of the flow of the fuel,
the tip portion of the nozzle body is provided with an inclined face which is inclined so as to be perpendicular to an extending direction of the taper portion, and
the nozzle hole is arranged on the inclined face.

12. The fuel injection valve according to claim 1, wherein,
a helical gear which has teeth inclined with respect to a center line, is provided serving as at least either one of the first fuel swirling device and the second fuel swirling device.

13. The fuel injection valve according to claim 1, wherein,
a plurality of helical gears, each of which has teeth which are inclined with respect to the center line at different inclination angles from each other, are provided as at least either one of the first fuel swirling device and the second fuel swirling device, and
the plurality of helical gears are stacked in such a way that, as the helical gear is located at further downstream side, the inclination angle becomes larger.

14. The fuel injection valve according to claim 1, wherein,
a cutout portion, that is hollowed outward in a radial direction, is formed on an inner peripheral surface of the nozzle hole and along the center line of the nozzle hole.

15. The fuel injection valve according to claim 14, wherein
a cross-section shape of the cutout portion is a circle.
